(19) United States
(12) Patent Application Publication
(10) Pub. No.: US 2026/0108034 A1
(43) Pub. Date: Apr. 23, 2026

(54) Electronic Contact Lens Case

(71) Applicant: AC Meisner Investments, LLC, Williams Bay, WI (US)

(72) Inventors: Christopher David Meisner, Lake Geneva, WI (US); Jacob William Speckman, Neenah, WI (US); Levi Dennis Speckman, Elkhorn, WI (US)

(21) Appl. No.: 19/366,198

(22) Filed: Oct. 22, 2025

Related U.S. Application Data
(60) Provisional application No. 63/710,110, filed on Oct. 22, 2024.
(60) Provisional application No. 63/722,445, filed on Nov. 19, 2024.
(60) Provisional application No. 63/739,003, filed on Dec. 26, 2024.
(60) Provisional application No. 63/741,737, filed on Jan. 3, 2025.

(51) Int. Cl. A45C 15/06; A45C 11/00; F21S 9/03; F21S 9/04; F21V 23/04; F21V 31/00; H05B 47/16

(52) U.S. Cl. CPC A45C 15/06; A45C 11/005; F21S 9/03; F21S 9/04; F21V 23/0485; F21V 31/005; H05B 47/16

(57) ABSTRACT

A contact lens case is provided that includes a main body, at least two caps, and a lighting circuit. The main body defines at least two lens bays on one side of the main body and a compartment on an opposite side of the main body. One of the caps is removably attached to one of the at least two lens bays and another cap is removably attached to another of the at least two lens bays. A lighting circuit is housed in the compartment. The lighting circuit includes a power source, at least one light source, and a control input to control an illumination state of the at least one light source. The contact lens case provides an indication as to when to change one's contact lenses and/or contact lens case. The contact lens case also provides for remote communication with a user device.

### CROSS-REFERENCE TO RELATED APPLICATIONS

This application claims the benefit of U.S. Provisional Application No. 63/710,110 filed Oct. 22, 2024, U.S. Provisional Application No. 63/722,445 filed Nov. 19, 2024, U.S. Provisional Application No. 63/739,003 filed Dec. 26, 2024, and U.S. Provisional Application No. 63/741,737 filed Jan. 3, 2025, which are all incorporated herein by reference in their entireties.

### FIELD

This disclosure relates generally to contact lenses and, more particularly, to illumination for contact lens cases.

### BACKGROUND

Over 80 million Americans sleep in common areas with others, including college dormitories, military barracks, and co-sleeping with their children. In addition, over 40% of the world goes to bed at a different time than their spouse because of work shifts, business travel, and personal preferences running the gamut from late-night readers to early-bird risers.

In many homes, the bathroom coincides with the bedroom such that lighting the bathroom area permeates the bedroom. Many bathroom tasks can be done in complete darkness so not to wake someone still sleeping. For instance, washing your face, brushing and flossing teeth, showering, and using the toilet can be done by feel, touch and/or muscle memory or using the light of the moon. However, for the millions of contact lens wearers, ample light is important. Many contact lens wearers resort to turning on enough light to perform the delicate process of putting in or taking out contact lenses, which is usually done twice a day. Turning on a light (e.g., of the bathroom) can light up the whole room including the sleeping area. To avoid this amount of light, studies show lens wearers attempt to use the flashlight feature on their mobile phone, leaving only one hand to unscrew the contact lens case and handle a precious and expensive contact lens, which runs the risk of incorrectly applying the contact lens to their eye or dropping the contact lens. Additionally, as mobile phones often carry bacteria, touching a mobile phone prior to handling contacts can result in eye infections (e.g., conjunctivitis, keratitis) and the transmission of other pathogens. The lack of light can also make it difficult to apply, manipulate, and recase contact lenses when remote from one's usual place of contact lens insertion/removal, such as at one's desk or when camping.

There also can be inadequate light during the day or in a fully lit room. For instance, even in a fully-lit room, it still can be challenging to confirm if a lens is on one's fingertip, if enough solution is in the lens bays of the contact case, and if the contact lens was successfully placed the lens in the case bay or if it is sitting on the counter drying out.

Additionally, many contact lenses come with prescribed or recommended usage periods, such that the lenses are to be replaced daily, weekly, monthly, etc. Many contact lens users, however, neglect to track how long they have been using a particular pair of contact lenses, which can result in exceeding the recommended usage period. Exceeding the recommended usage period can result in biofilm formation on the contact lenses, increasing the risk of eye irritation, infection, dry eye or other harmful consequences.

The Center for Disease Control (CDC) also urges contact lens wearers to replace their contact storage case at minimum every 90 days due to risks associated with bacteria growth, however, many contact wearers do not comply with this recommendation.

### BRIEF DESCRIPTION OF THE DRAWINGS

FIG. 1 is a perspective view of a self-illuminated contact case body;

FIG. 2 is another perspective of the self-illuminated contact case body of FIG. 1;

FIG. 3 is a bottom perspective view of the self-illuminated contact case body of FIG. 1;

FIG. 4 is a top plan view of another embodiment of a self-illuminated contact case;

FIG. 5 is a top plan view of the contact case of FIG. 4 in an illuminated state;

FIG. 6 is a top plan view of the contact case of FIG. 4 in an illuminated state and with one cover removed;

FIG. 7 is a top plan view of the contact case of FIG. 4 in an illuminated state and with both covers removed;

FIG. 8 is a top perspective view of the contact case of FIG. 4 in an illuminated state and with both covers removed;

FIG. 9 is a side perspective view of the contact case of FIG. 4 in an illuminated state and with both covers removed;

FIG. 10 is a bottom perspective view of the contact case of FIG. 4 in an illuminated state and with both covers removed;

FIG. 11 is a bottom plan view of the contact case of FIG. 4 in an illuminated state and with both covers removed;

FIG. 12 is a bottom perspective view of a body of the contact case of FIG. 4 with a printed circuit board removed;

FIG. 13 is another a bottom plan view of the contact case of FIG. 4 in an illuminated state and with both covers removed;

FIG. 14 is another bottom perspective view of a body of the contact case of FIG. 4 with a printed circuit board removed and showing the other side of the printed circuit board;

FIG. 15 is a schematic of a circuit for use with a printed circuit board;

FIG. 16 is a side elevational view of the contact case of FIG. 4;

FIG. 17 is an end elevational view of the contact case of FIG. 4;

FIG. 18 is a top plan view of the contact case of FIG. 4;

FIG. 19 is a perspective view of the contact case of FIG. 4;

FIG. 20 is a bottom perspective view of a cover of the contact case of FIG. 4;

FIG. 21 is another bottom perspective view of the cover of the contact case of FIG. 4;

FIG. 22 is a side elevational view of the cover of the contact case of FIG. 4;

FIG. 23 is a bottom plan view of the cover of the contact case of FIG. 4;

FIG. 24 is a perspective view of a cover for a bottom compartment of the body of the contact case of FIG. 4;

FIG. 25 is a plan view of a cover for the bottom compartment of the body of the contact case of FIG. 4;

FIG. 26 is a side elevational view of the cover for a bottom compartment of the body of the contact case of FIG. 4;

FIG. 27 is a top plan view of a contact lens case;

FIG. 28 is a bottom plan view of the contact lens case of FIG. 27 with a light device attached thereto;

FIG. 29 is a top perspective view of another self-illuminated contact case, having a case body and covers;

FIG. 30 is bottom perspective view of the contact case body and covers of FIG. 29;

FIG. 31 is a top, front perspective view of the contact case body of FIG. 29 illuminated;

FIG. 32 is a top, rear perspective view of the contact case body of FIG. 29 illuminated;

FIG. 33 is a bottom view of the contact case body of FIG. 29 with the bottom removed showing a bottom side of a printed circuit board;

FIG. 34 is a bottom view of the contact case body of FIG. 29 with the bottom removed and separated from the printed circuit board showing the top side of the printed circuit board;

FIG. 35 is a bottom view of the printed circuit board of FIG. 34;

FIG. 36 is a bottom view of the contact case body like FIG. 29 showing the printed circuit board in a compartment of the contact case body;

FIG. 37 is a cross-section view of the contact case body of FIG. 36 without a cover over the compartment;

FIG. 38 is a top perspective of the contact case body of FIG. 36 with a portion of the case body cut away;

FIG. 39 is a top plan view of the printed circuit board of the contact case body of FIG. 36;

FIG. 40 is a bottom plan view of the printed circuit board of the contact case body of FIG. 36;

FIG. 41 is a schematic of a circuit for use with a printed circuit board like the one shown in FIG. 39;

FIG. 42 is a perspective view of a contact lens case according to another embodiment;

FIG. 43 is a top plan view of the contact lens case of FIG. 42;

FIG. 44 is a cross-section view of the contact lens case of FIG. 42 taken along line 44-44 of FIG. 43;

FIG. 45 is a perspective view of the contact lens case of FIG. 42 shown in an illuminated state and with one of the caps removed;

FIG. 46A is a schematic of a portion of an electrical circuit of the contact lens case of FIG. 42;

FIG. 46B is a schematic of a portion of the electrical circuit of the contact lens case of FIG. 42;

FIG. 47 is a top view of a circuit board of the contact lens case of FIG. 42;

FIG. 48 is a schematic diagram of a contact lens system including the contact lens case of FIG. 42 and a user device;

FIG. 49 is a top view of a contact lens case according to another embodiment with the caps removed and having light arrays at the lens bays;

FIG. 50 is a top view of the contact lens case of FIG. 49 with the light arrays illuminated to indicate a remaining time on a timer; and

FIG. 51 is a perspective view of a contact lens case according to another embodiment.

### DETAILED DESCRIPTION

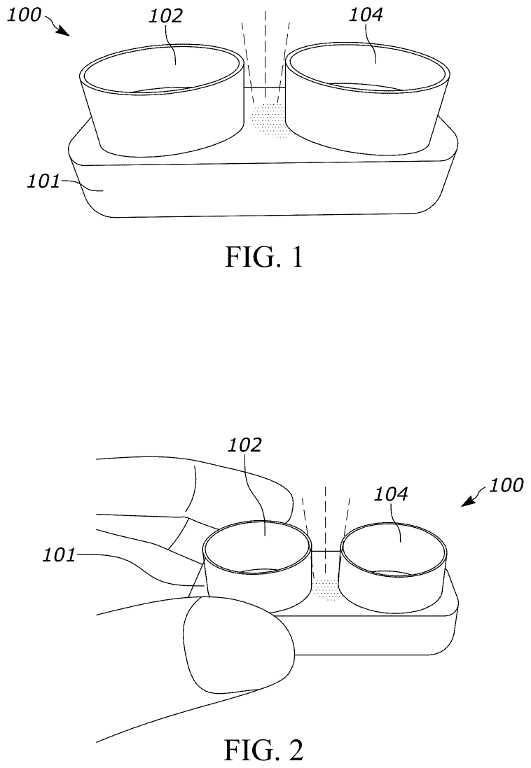

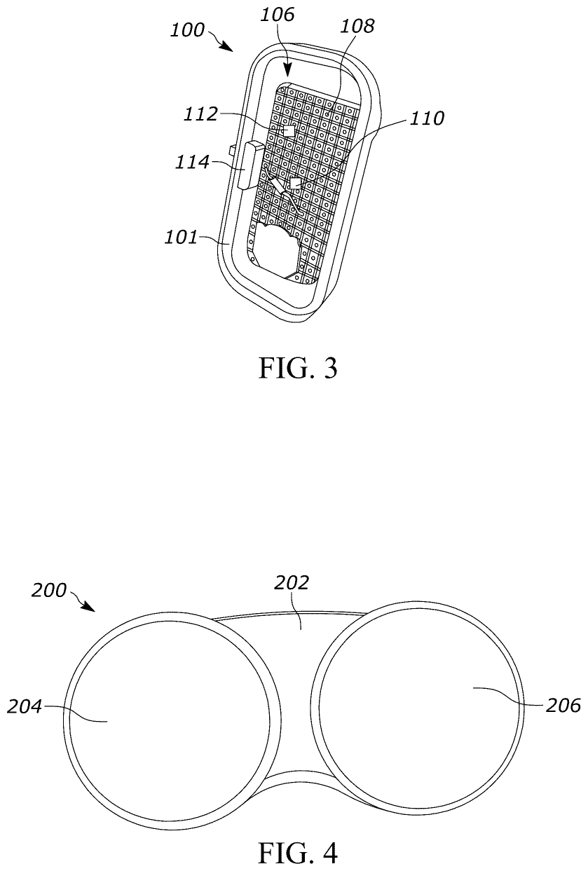

FIGS. 1-3 show a self-illuminated contact case body 100. The contact case body 100 includes a base 101 and a pair of lens bays 102, 104 on the base 101 that may each be used to store contact solution and a contact lens. The contact case body 100 is molded or printed from a cost-effective material, such as plastic. The preferred material is semi-transparent or translucent so that light (indicated with stippling) can permeate through the material and into the lens bays 102, 104. The body 100 defines an internal compartment 106 in the base 101 sized to house a printed circuit board (PCB) 108. The PCB 108 includes an electrical circuit having at least one light source 110, a power source such as a battery 112 for powering the light source 110, a switch 114 for activating and deactivating the light source 110, and other circuitry necessary for operating the light.

More specifically, the components of the PCB 108 could be as follows:

| | Quan- | | |
|---|---|---|---|
| Description | tity | Manufacturer | Part Number |
| BATTERY RETAINER | 1 | Keystone | 3034 |
| COIN 20 MM SMD | | Electronics | |
| BATTERY LITHIUM 3 V | 1 | Jauch Quartz | CR2032 |
| COIN 20 MM | | | |
| RESISTOR 100 OHM 1% | 2 | Yageo | TL2202EEYB |
| 1/16W 0402 | | | |
| SWITCH PB DPDT 0.1 A | 1 | E-Switch | TL2202EEYB |
| 30 V | | | |
| LED NEUTRAL WHITE | 2 | Luminus | MP-3014- |
| 4000K 3014 | | Devices Inc. | 1100-40-80 |

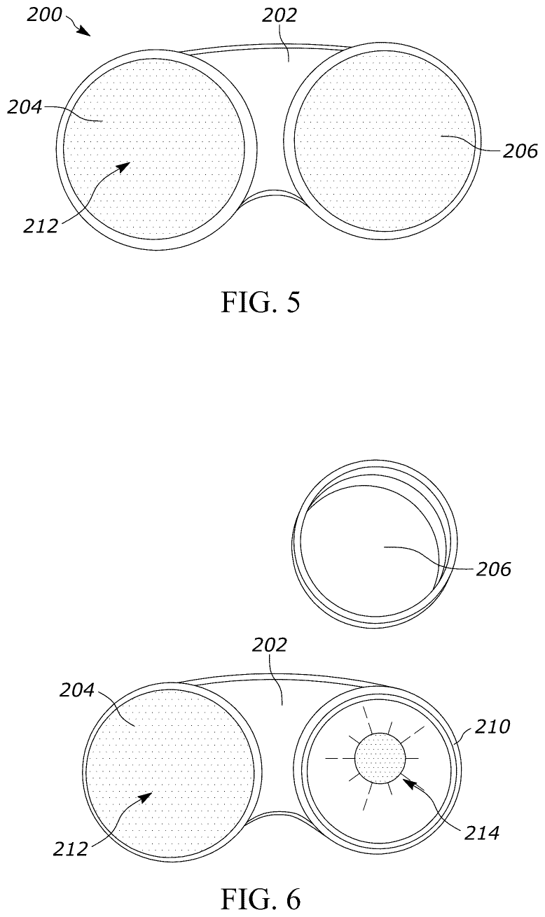

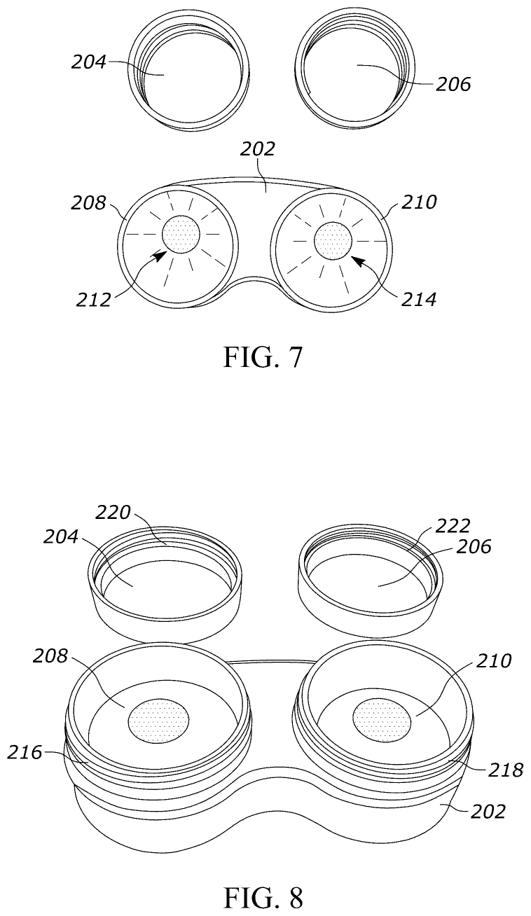

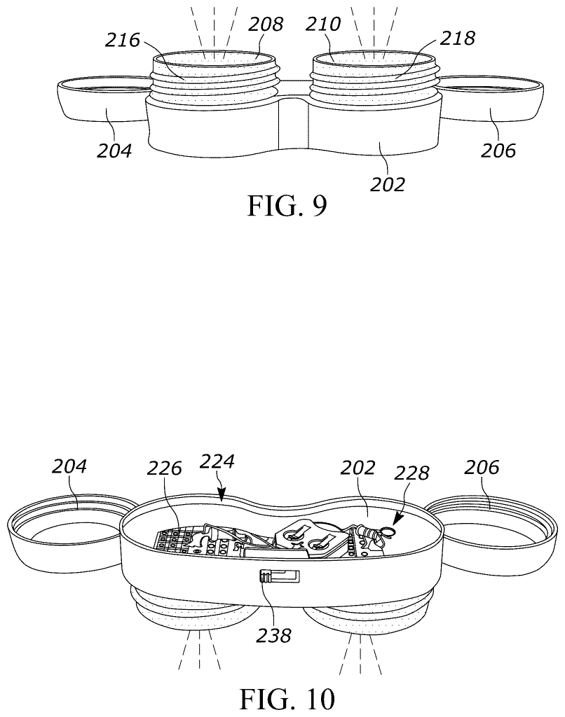

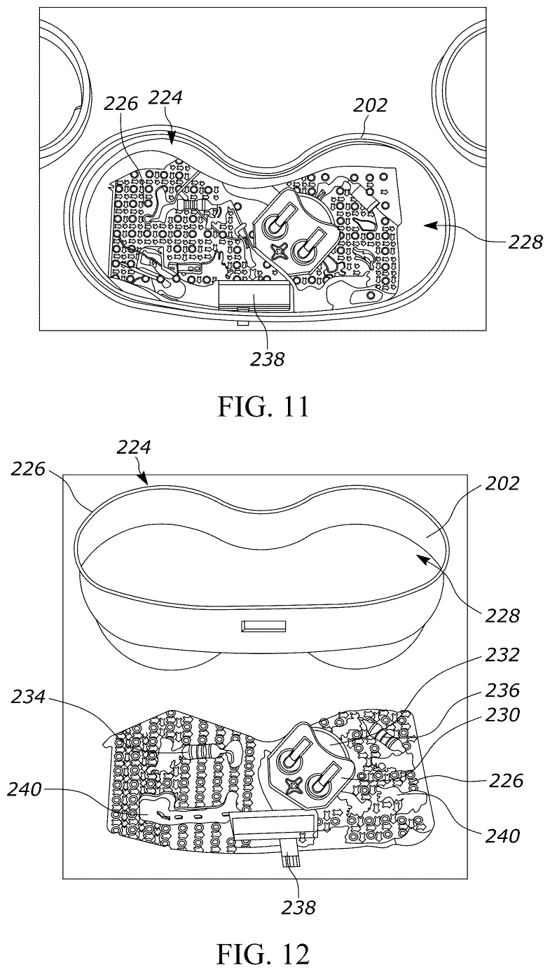

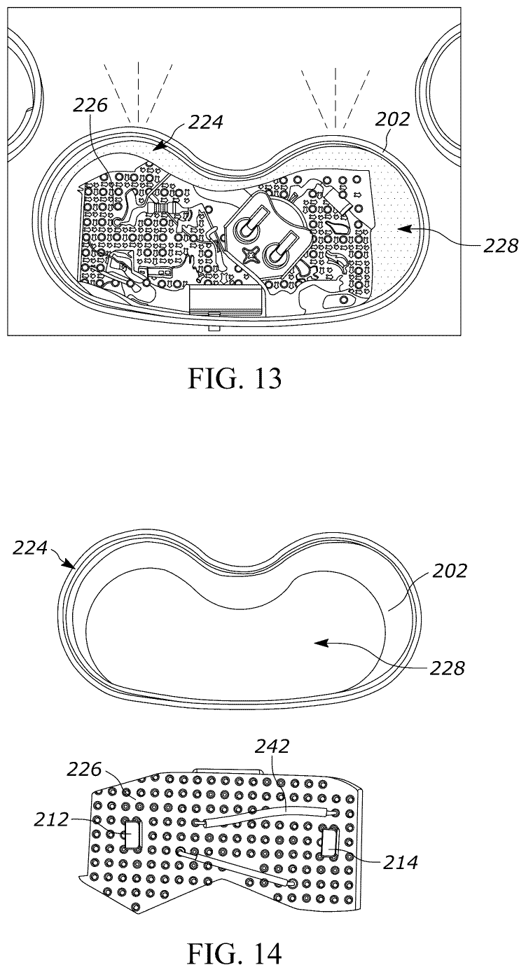

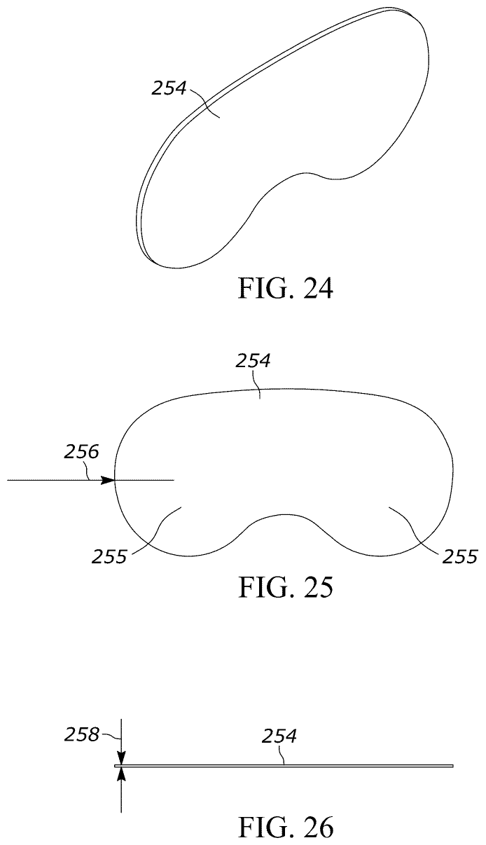

FIGS. 4-14 show another embodiment of a contact case 200 having a contact case body 202 and covers or caps 204, 206. More specifically, FIG. 4 shows the contact case body 202 having an arcuate overall shape and caps 204, 206 on each of its contact bays 208, 210 (see FIG. 7). As shown in FIG. 14, the contact case 200 includes a circuit board 226 having a pair of light emitting diodes (LEDs) 212, 214. FIG. 5 shows the contact case 200 with the LEDs 212, 214 turned on and illuminating the contact case 200 (as indicated with the stippling). One LED 212, 214 is located at each of the contact bays 208, 210 of the contact case body 202. FIG. 6 shows the LEDs 212, 214 turned on to illuminate the contact case 200 like FIG. 5, but with the right cap 206 removed from the right bay 210. FIG. 7 shows the LEDs 212, 214 turned on to illuminate the contact case 200 like FIG. 5, but with both caps 204, 206 removed from their respective bays 208, 210. FIGS. 8 and 9 show threading 216, 218 of the contact case body 202 at each lens bay 208, 210 and threading 220, 222 in the caps 204, 206 for removably attaching the caps 204, 206 to the lens bays 208, 210. FIGS. 10, 11, and 13 show a bottom 224 of the contact case body 202 and a PCB 226 housed in a compartment 228 defined by the body 202. A bottom cover 254 (see FIGS. 24-26) may be placed over the compartment 228 of the case body 202 and sealed to the case body 202 to make the compartment 228 watertight. FIGS. 12 and 14 show the PCB 226 removed from the compartment 228 of the body 202. In FIG. 12, the PCB 226 is shown with a battery retainer 230 with a coin battery 232 therein, two resistors 234, 236, a switch 238 for turning the LED lights 212, 214 on and off, and solder connections 240 electrically and mechanically connecting the electrical components to the PCB 226. In FIG. 14, the other side of the PCB 226 is shown having the two LED lights 212, 214 and connecting wires 242.

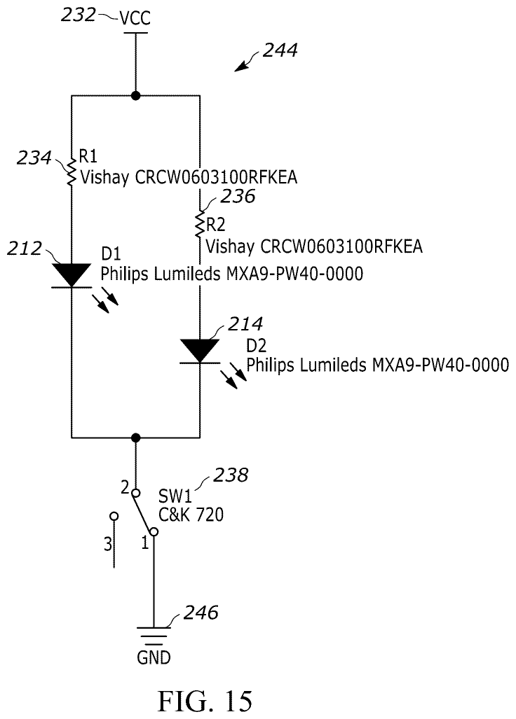

FIG. 15 shows a schematic of the electrical circuit 244 on the PCB 226 and alternate component manufacturers to those listed above. More specifically, the circuit 244 includes the battery (VCC) 232, a resistor (R1, R2) 234, 236 between the battery (VCC) 232 and each of the LED lights (D1, D2) 212, 214, and the switch (SW1) 238 for opening and closing the circuit 244 (e.g., to electrically connect or disconnect the LED lights 212, 214 to ground (GND) 246).

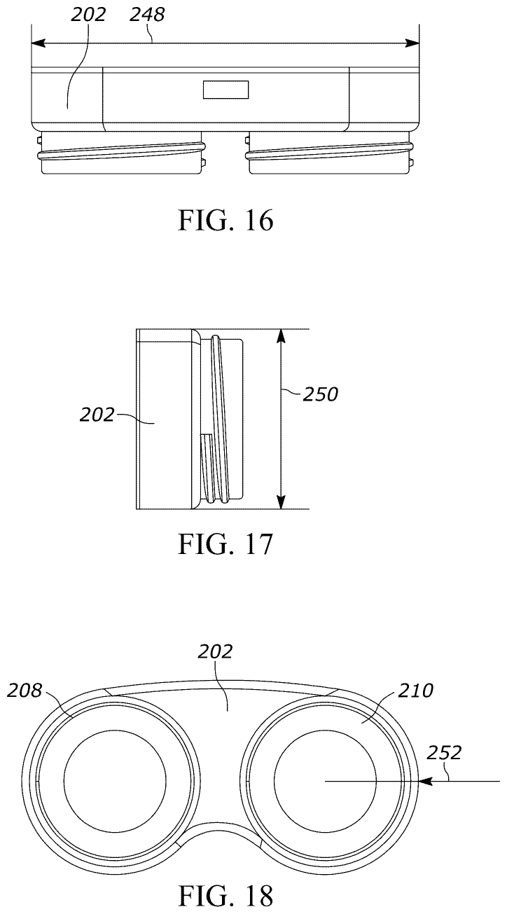

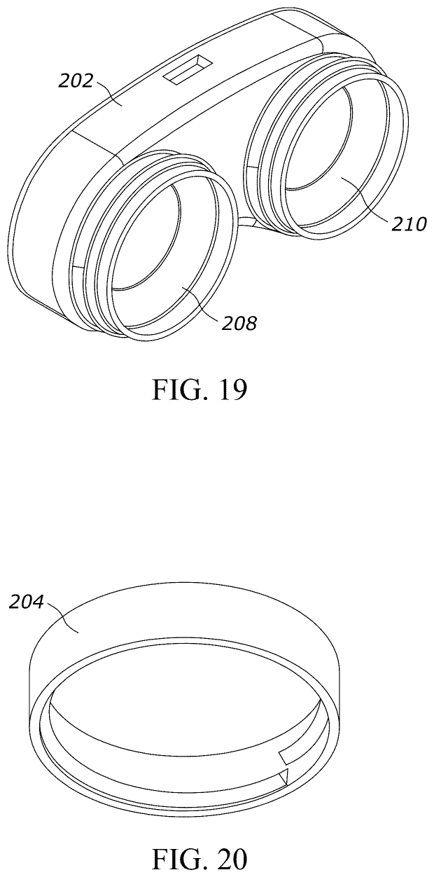

FIGS. 16-19 show the contact case body 202 of the contact case 200 of FIG. 4 including dimensions. For instance, the body 202 is shown to have a maximum length 248 of 64 millimeters and a maximum width 250 of 31.53 millimeters. Each of the lens bays 208, 210 is shown with a radius of curvature 252 of 15 millimeters.

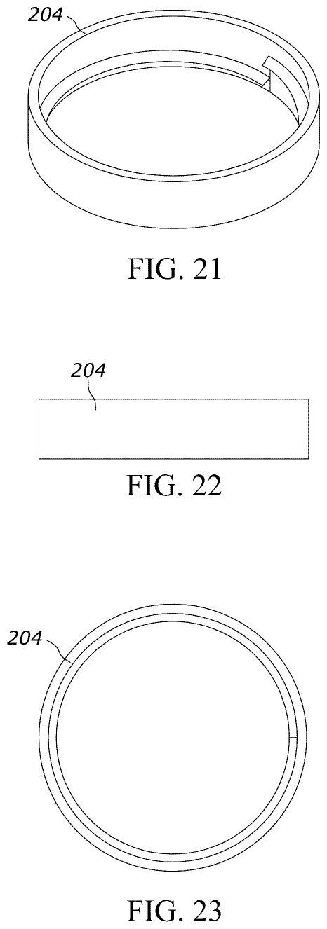

FIGS. 20-23 show the cap 204 for the lens bays 208, 210 of the contact case body 202 of the contact case 200 of FIG. 4. The second cap 206 may be identical to the cap 204. In some embodiments, the caps 204, 206 are different (e.g., different colors, profiles) to enable the caps 204, 206 to be associated with a right eye contact lens or a left eye contact lens stored in the contact case 200.

FIGS. 24-26 show the bottom cover 254 for the compartment 228 of the contact case body 202 of FIG. 4. The bottom cover 254 is securable to the contact case body 202 to close the compartment 228 with the PCB 226 therein. In one embodiment, the bottom cover 254 is secured to the contact case body 202 by a snap connection, for example, the bottom cover 254 may be snapped over a protrusion of the contact case body 202 that holds the bottom cover 254 to the contact case body 202. Each lobe 255 of the bottom cover 254 has a radius of curvature 256 of 14.21 millimeters and a thickness 260 of 0.5 millimeters.

The contact case body 202 is preferably a translucent seamless unibody construction made of plastic. The translucent nature allows illumination and emission of light from the LED lights 212, 214 but hides the existence of internal components, such as the PCB 226 in the compartment 228. In some embodiments, the contact case body 202 is transparent. The light emitted from the contact case body 202 aids the user in taking out and/or putting in their contact lenses, for example, to aid in locating and handling their contact lenses, especially in a dark environment. The contact case body 202 may emit light with a low brightness or a soft color to avoid negatively affecting the user's circadian rhythm.

The caps 204, 206 are preferably translucent or transparent to be illuminated and emit light from the LED lights 212, 214 even when the caps 204, 206 are installed. This enables the contact case 200 to act as a small, low light device (such as a low light flashlight) as well, which can assist in locating other items or helping to navigate, such as in the house or outdoors, without using a bright light. This could help avoid negative effects on circadian rhythms.

The contact case 200 (e.g., the contact case body 202 and/or the caps 204, 206) could be made in different colors (e.g., different colored plastic) to aid in distinguishing between different contact cases 200, for example, in a house where multiple people have a contact case 200.

The contact case 200 could be packaged so that it does not consume much retail space in a store. For instance, it could be on a hanging card or package on an end cap or at the checkout area. The packaging could also provide access to illuminate the contact case 200 so that a purchaser could test the contact case 200.

The direct light from the illuminated contact case 200 includes several benefits as described above. It also helps confirm that your contact lenses are not inside out and to aid in easy inspection of your contacts for tears, fungus or need of replacing.

The LED lights 212, 214 and circuitry 244 could also function as mood lights. For instance, the LED lights 212, 214 could switch colors or could have an initial flashing sequence, such as when the contact case 200 is turned on then shifts to constant light after a predetermined period. With connectivity through a mobile application, as discussed below, users could also create or program the temperature or color of the lights to their preference.

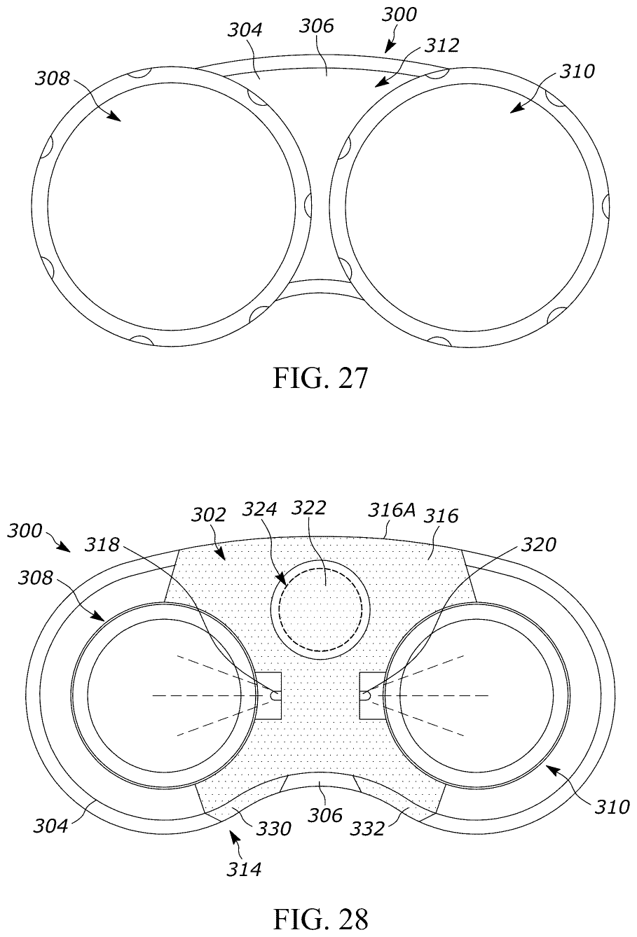

FIGS. 27 and 28 illustrate an alternative embodiment of a contact lens case 300. This lens case 300 may have the same components and features as the contact case 200 described above except that the light device 302 is not mounted inside but, instead, is mounted to the outside of a body 304 of the lens case 300. The light device 302 may be mounted anywhere to the body 304 of the lens case 300 but is shown mounted to the bridge 306 between the lens bays 308, 310. The light device 302 can be mounted to a top side 312 or a bottom side 314 of the bridge 306. The light device 302 is shown mounted to the bottom side 314 of the bridge 306.

The light device 302 includes a body or housing 316 that may be shaped and sized to mechanically snap on to the bridge 306 of the lens case 300. The housing 316 of the light device 302 may wrap around edges of the body 304 of the lens case 300 to secure the light device 302 thereto. For example, the housing 316 includes a first attachment wall 316A and one or more attachment arms 330, 332 opposite the first wall 316A that snap to the body 304 of the lens case 300. The first attachment wall 316A may be positioned to receive or wrap about the edge of the body 304 of the lens case 300 and the attachment arms 330, 332 may be deflected outward to receive the lens case body 304 therein and, upon the lens case body 304 being received therein, elastically return inward to hook the lens case body 304 and secure the light device 302 to the lens case body 304. The light device 302 may be removed from a lens case body 304, for example, when the user replaces their lens case or to clean their lens case. The light device 302 may be reattached to a new lens case. The light device 302 may be mounted to the lens case 300 in other manners. For instance, the light device 302 may include an adhesive layer that can be exposed by removing a pressure sealed protective layer and adhered to the bridge 306 to attach the lighting device 302 to the body 304 of the lens case 300. The body or housing 316 of the light device 302 may be translucent (with the stippling in the drawing indicating the housing 316 being illuminated).

The light device 302 may include LED lights 318, 320 that each face toward one of the lens bays 308, 310 to illuminate the lens bays 308, 310 from the bottom of the lens case body 304. A battery 322 powers the LED lights 318, 320. The battery 322 is in a sealed battery compartment 324 of the body or housing 316 of the light device 302. The light device 302 may include a PCB such as that discussed above.

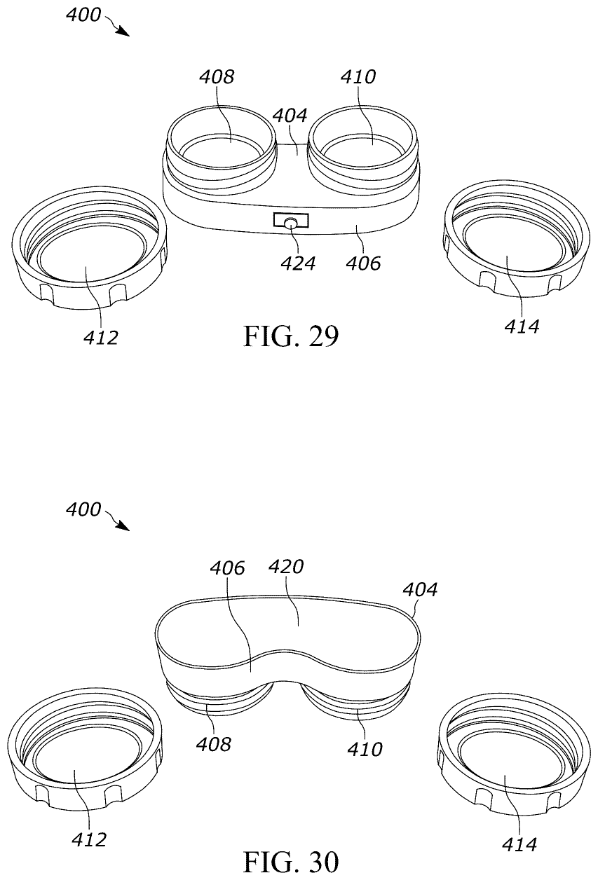

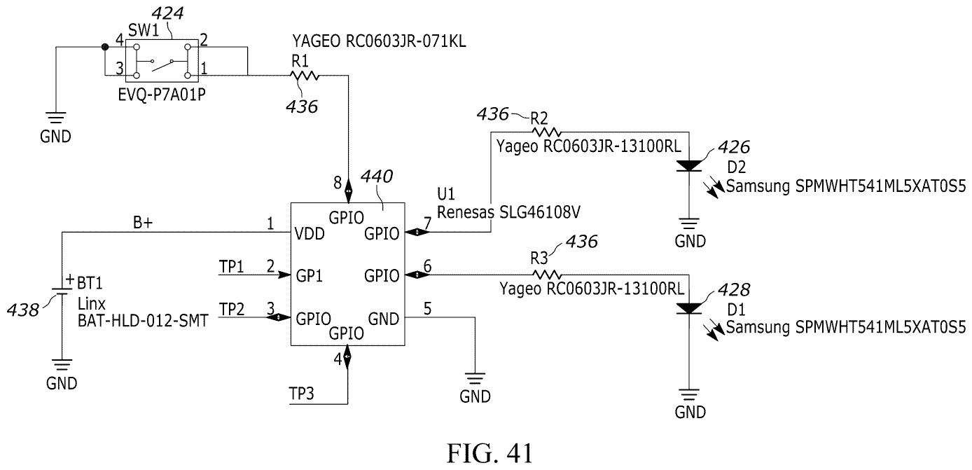

FIGS. 29-35 illustrate another alternate embodiment of a contact lens case 400. This case 400 is like the above cases with the primary difference being that contact lens case 400 includes a different circuit board 402. The contact lens case 400 includes a contact case body 404 with a base 406 defining a compartment 407 and contact lens bays 408, 410 on the base 406. The contact lens case 400 includes caps 412, 414 to cover and close the contact lens bays 408, 410. Components and circuits on the circuit board 402 may be those described above or in FIG. 41 as discussed below. This circuit board 402 defines four mounting holes 416 that each receive a portion of one of four pegs 418 extending from a cover 420 that mounts to the contact case body 404 to close the compartment 407 that houses the circuit board 402. More specifically, each peg 418 may extend through one of the holes 416 and into a socket 421 extending from a surface 422 at a bottom of the compartment 407. Each peg 418 may friction fit into one of the sockets 421 or be glued or welded into the socket 421. The circuit board 402 may be shaped similar to the profile of the housing compartment 407.

FIG. 29 illustrates a top front perspective view of the contact lens case 400. A switch 424 for activating LEDs of the contact lens case 400 is shown on the front in line with the bridge of the contact case body 404 between the lens bays 408, 410. The switch 424 may be anywhere on the contact lens case 400. In this embodiment, the switch 424 is a push button that may be pressed by the user to activate or deactivate the lights. The caps 412, 414 thread onto the contact case body 404 to close the two lens bays 408, 410 sized for storing and cleaning contact lenses in contact lens solution.

FIG. 30 illustrates a bottom rear perspective of the contact lens case 400. The bottom cover 420 may be removably attached to the contact case body 404 with a friction or snap fit. The bottom cover 420 alternatively may be permanently attached to the contact case body 404 with glue or a weld.

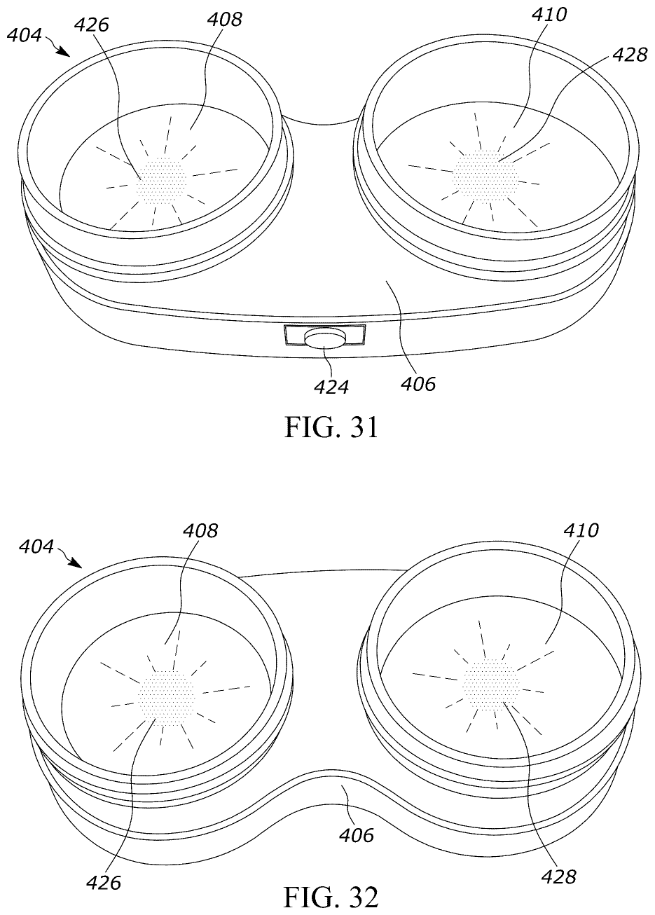

FIGS. 31 and 32 show the contact lens case 400 illuminated (as shown with stippling) with a pair of illumination sources 426, 428. With the illustrated embodiment, there are two illumination sources 426, 428, and each is generally centered below a respective bay 408, 410. There may be any number of illumination sources. The bottom of the bays 408, 410 may act as a light diffuser to spread the light across the bottom of the bays 408, 410.

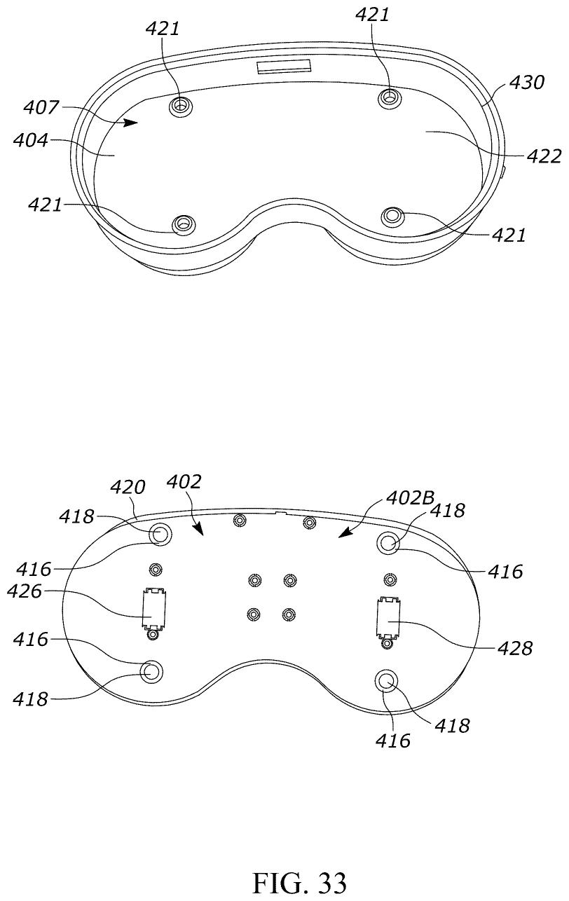

FIG. 33 illustrates the contact lens case 400 with the bottom cover 420 removed and the circuit board 402 separated from the contact case body 404. The bottom surface 422 of the base 406 shows the four sockets 421 projecting into the compartment 407. The circuit board 402 is attached to the bottom cover 420. The pegs 418 projecting from the bottom cover 420 are visible at the four holes 416 in the circuit board 402. The holes 416 are positioned in a rectangular pattern. The pegs 418 and sockets 421 are in the same pattern. The circuit board 402 includes two illumination sources 426, 428, such as LEDs. The bottom cover 420 and circuit board 402 have perimeter profiles that are substantially the same or identical. The size of the bottom cover 420 may be slightly larger than the circuit board 402 and may sit on a ledge 430 formed at an opening into the compartment 407 of the contact case body 404.

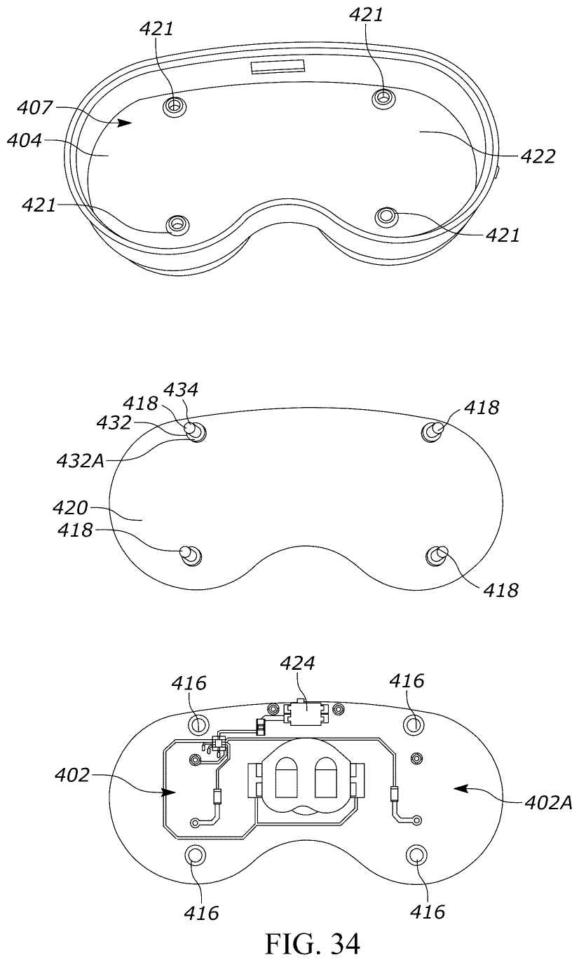

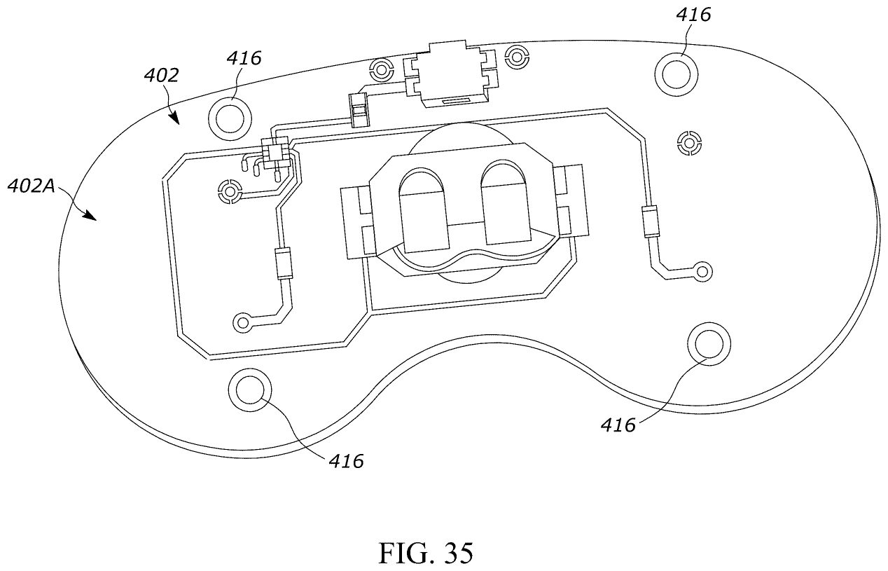

FIGS. 34 and 35 show the circuit board 402 removed from the bottom cover 420. The circuit board 402 is turned on its top side to show its bottom side. Each of the pegs 418 includes a bottom portion 432 with a diameter larger than the remainder 434 of the peg 418. The circuit board 402 sits on the end face 432A of the bottom portion 432 of the peg 418 while the remainder 434 of the peg 418 extends through the hole 416 of the circuit board 402. The length of the bottom portions 432 is set to provide clearance between the printed circuit board 402 and the bottom surface 422 of the compartment 407 for the electrical components mounted to the circuit board 402. All the electrical components except the illumination sources 426, 428 are on the bottom side 402A of the circuit board 402. The sockets 421 projecting from the surface 422 of the contact lens body 404 engage the circuit board 402 to provide clearance between the bottom surface 422 of the compartment 407 and the circuit board 402 for the illumination sources 426, 426 (e.g., LEDs) on the top side 402B of the circuit board 402. The electrical components may include those described herein.

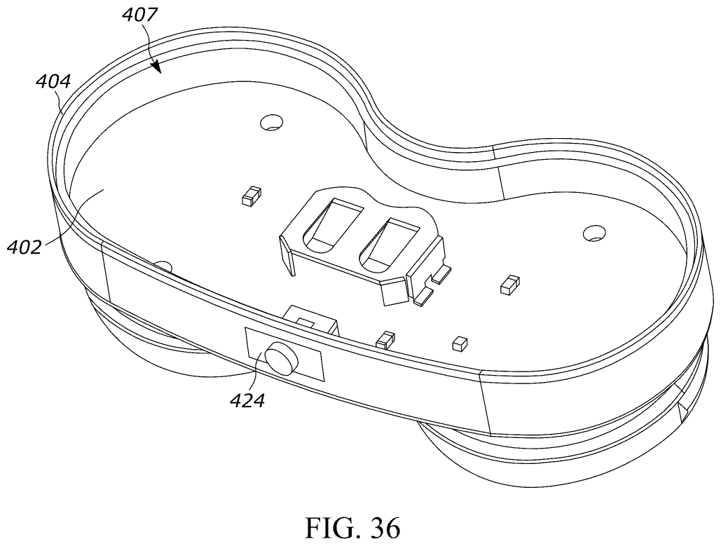

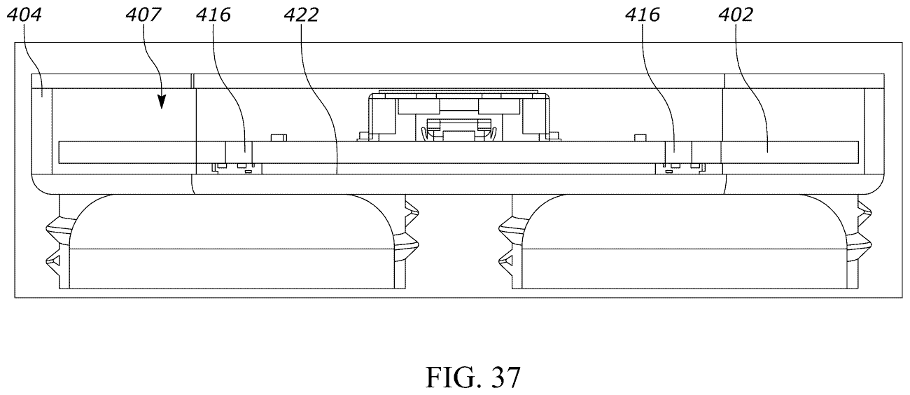

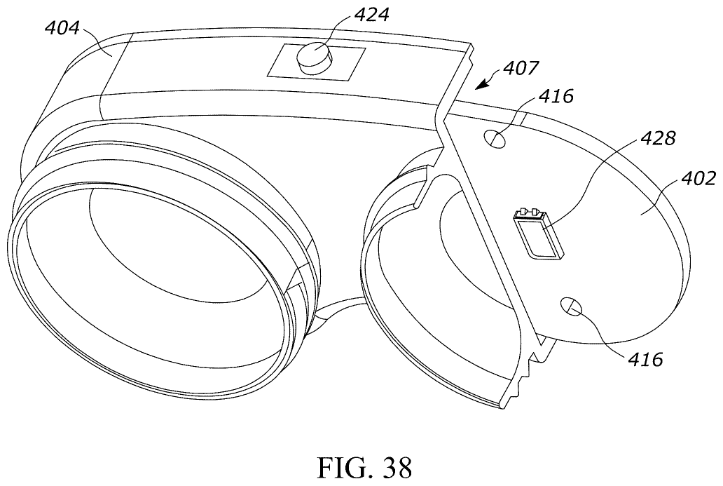

FIGS. 36-40 are additional views of the contact lens case 400 of FIGS. 29-35. FIG. 36 shows the contact lens body 404 with the bottom cover 420 removed exposing the circuit board 402. FIG. 37 is a cross-section view of the contact lens case 400 without the bottom cover 420 for the circuit board compartment 407. This view shows the clearance between the circuit board 402 and the bottom surface 422 of the circuit board compartment 407. The view also shows two of the holes 416 through the circuit board 402 for two of the pegs 418 extending from the bottom cover 420.

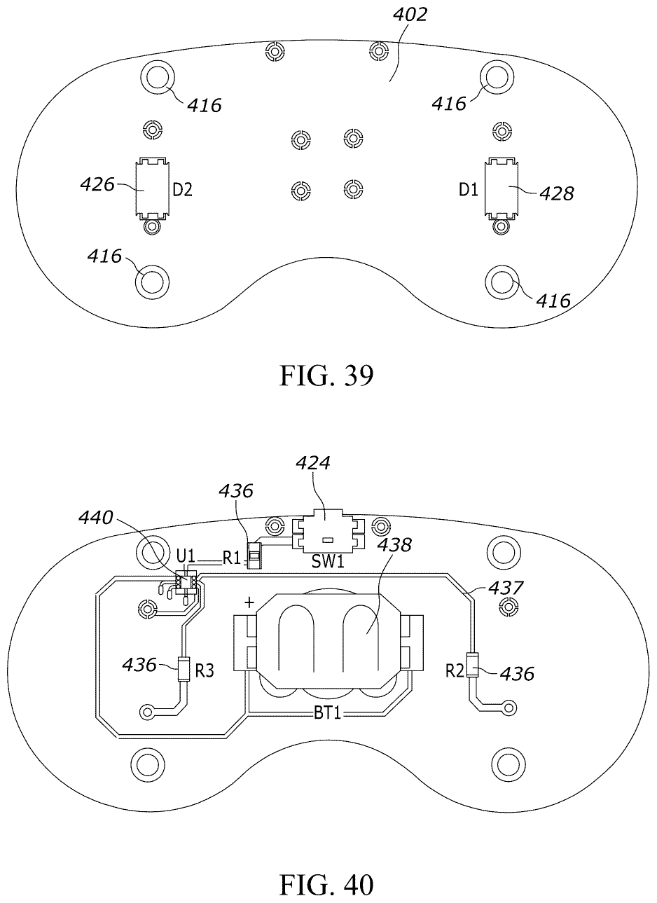

FIG. 38 shows a partial cross-section view of the contact lens body 404. In this view, the circuit board 402 is not sectioned. This view also shows two of the holes 416 for two of the pegs 418 extending from the bottom cover 420. One of the illumination sources 428 is shown. FIG. 39 shows all four of the peg holes 416 of the circuit board 402 and both illumination sources 426, 428.

FIG. 40 illustrates a top side of the circuit board 402, showing the electrical components and the printed conductors 437 (e.g., the circuit trace) connecting them. The electrical components include the switch (SW1) 424, three resistors (R1, R2, and R3) 436, a battery holder (BT1) 438, and a programmable mixed-signal matrix integrated circuit (U1) 440.

FIG. 41 is a schematic for a lighting circuit 442 of the circuit board 402. The lighting circuit 442 may be used with any of the foregoing contact lens cases. The lighting circuit 442 is shown using the following electrical components as noted on the schematic.

| | Quan- | Manufac- | |
|---|---|---|---|
| Description | tity | turer | Part Number |
| BATTERY | 1 | Linx | BAT-HLD-012-SMT |
| RETAINER COIN | | | |
| 20 MM SMD | | | |
| BATTERY LITHIUM | 1 | Jauch | CR2032 |
| 3 V COIN 20 MM | | Quartz | |
| RESISTOR | 2 | Yageo | RC0603JR-13100RL |
| SWITCH PB DPDT | 1 | Panasonic | EVQ-P7A01P |
| 0.1 A 30 V | | | |
| LED NEUTRAL | 2 | Samsung | SPMWHT541ML5XAT0S5 |
| WHITE 4000K 3014 | | | |
| RESISTOR | 1 | Yageo | RC0603JR-071KL |
| GREENPAK | 1 | Renesas | SLG46108V |
| PROGRAMMABLE | | | |
| MIXED-SIGNAL | | | |
| MATRIX | | | |

The integrated circuit 440 receives an input from the switch 424 at pin 8 indicating whether the user is closing the switch, for example, pressing the button. The integrated circuit 440 determines to change the state of the illumination sources 426, 428 based on input from the switch 424. For example, where the illumination sources 426, 428 are off, upon receiving input from the switch 424, the integrated circuit 440 may output a signal from pins 6 and 7 to turn on the illumination sources 426, 428. The integrated circuit 400 may receive a clock signal and automatically turn the illumination sources 426, 428 off after a period of time (e.g., two minutes). Where the illumination sources 426, 428 are on, upon receiving input from the switch 424, the integrated circuit 440 may turn off the illumination sources 426, 426. The integrated circuit 440 may also be configured to cause the illumination sources 426, 428 to be illuminated in flashing patterns, different colors (e.g., on an RGB color scale) or in different modes as discussed elsewhere in this disclosure, for example, based on the input received from the switch 424 (e.g., multiple button presses, holding the button for a set period of time, etc.).

The lighting circuit also could use the following electrical components.

| Description | Quantity | Manufacturer | Part Number |
|---|---|---|---|
| BATTERY RETAINER COIN | 1 | Keystone | 3000 |
| 20 MM SMD | | | |
| COIN CELL BATTERY 3 V | 1 | Renata Batteries | CR1225.IB |
| 12.5 × 2.5 mm | | | |
| THICK FILM RESISTOR, 100 | 2 | Yageo | RC0603JR-13100RL |
| OHM, 100 mW, 5% | | | |
| SWITCH TACTILE N.O. | 1 | Panasonic | EVQ-P7A01P |
| RECTANGULAR BUTTON | | Electrical | |
| GULL WING 0.05 A 12 VDC | | Components | |
| 2.2N SMD EMBOSSTED T/R | | | |
| LED LM561C NEUTRAL | 2 | Samsung | SPMWHT541ML5XAT0S5 |
| WHITE 4000K 5630 | | | |
| RES 1K OHM 5% 1/10w 0603 | 1 | Yageo | RC0603JR-071KL |
| GREENPAK | 1 | Renesas | SLG46108V |
| PROGRAMMABLE MIXED- | | | |
| SIGNAL MATRIX (IC CPLD | | | |
| 7MC 8STQFN) | | | |

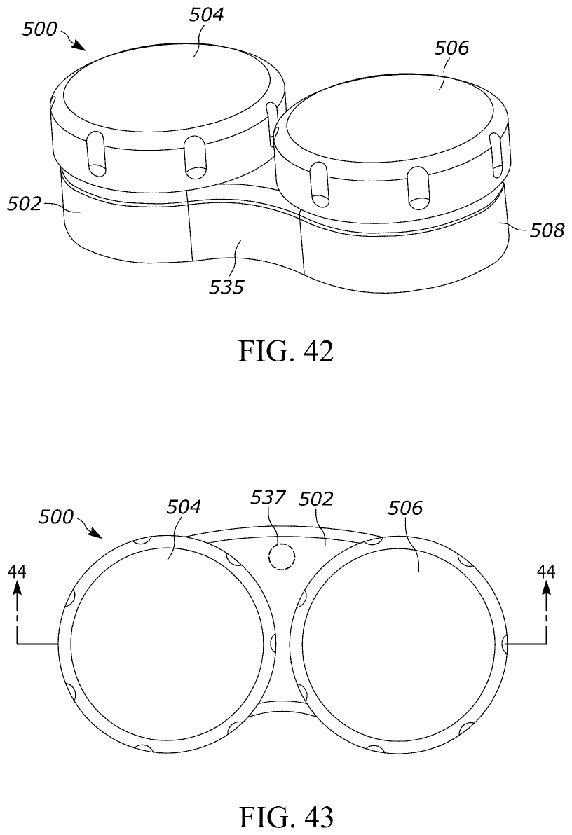

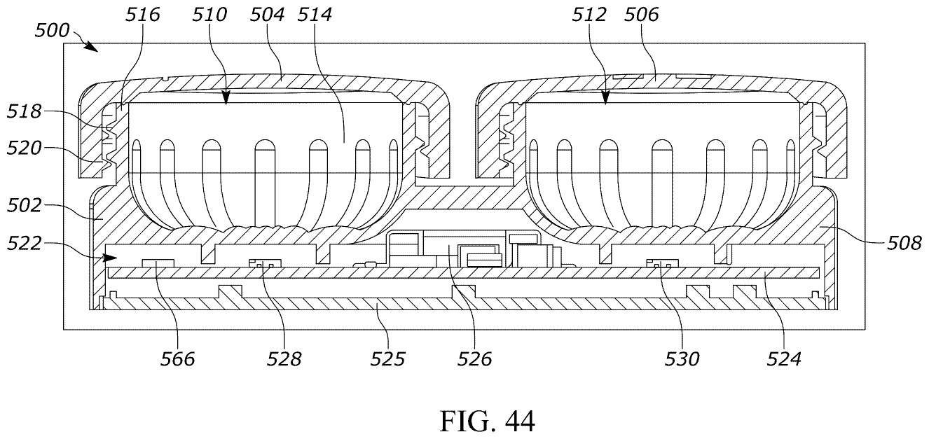

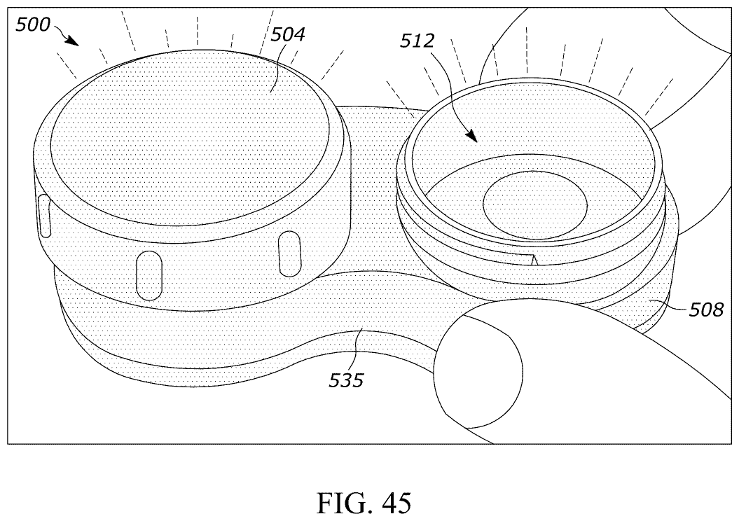

Regarding FIGS. 42-45, a contact lens case 500 is provided according to another embodiment. The contact lens case 500 is similar in many respects to the embodiments discussed above. The contact lens case 500 includes a case body 502 and two closure caps 504, 506. The case body 502 includes a base 508 and two lens bays 510, 512 (see FIG. 44) on the base 508. The lens bays 510, 512 each define a recess 514 to receive a contact lens and contact solution. The lens bays 510, 512 each include an attachment wall 516 extending upward from the base 508. The closure caps 504, 506 are removably securable to the attachment wall 516 of a lens bay 510, 512 to close the associated lens bay 510, 512. In one embodiment, the attachment wall 516 of the lens bay includes threading 518 to engage corresponding threading 520 of the closure cap 504, 506 to secure the closure cap thereto. FIG. 45 shows the contact lens case 500 with one of the closure caps 506 removed to provide access to the interior of the lens bay 512.

The contact lens case 500 includes a compartment 522 in the base 508 of the case body 502 housing a circuit board 524. In some embodiments, the interior surface of the compartment 522 may include light diffusing features thereon to diffuse the light passing therethrough. For example, the interior surface of the compartment 522 may have an uneven surface with bumps, dimples, waves or other such light diffusing structure to scatter the light passing therethrough. The interior surface of the closure caps 504, 506 may similarly include such light diffusing features to diffuse the light passing therethrough.

The contact lens case 500 includes a bottom cover 525 attachable to the base 508 to close the compartment 522. In some embodiments, the bottom cover 525 may be permanently secured to the case body 502, for example, by welding or with an adhesive. In other embodiments, the bottom cover 525 is removably secured to the case body 502, for example, by a snap fit connection or with fasteners (e.g., one or more screws). The contact lens case 500 may include a seal (e.g., a gasket or O-ring) between the base 508 and the bottom cover 525 such that the compartment 522 is fluid tight when the bottom cover 525 is secured to the base 508. In one embodiment, the bottom cover 525 may be removable, for example, to permit a battery 526 of the contact lens case 500 to be replaced.

In some embodiments, the battery 526 is rechargeable. As one example, the circuit board 524 may include a wireless charging circuit that interacts with a wireless charger to charge the battery 526 without having to remove the bottom cover 525 of the case. As another example, the case body 502 includes a port via which a charging cord is able to be attached to charge the battery 526.

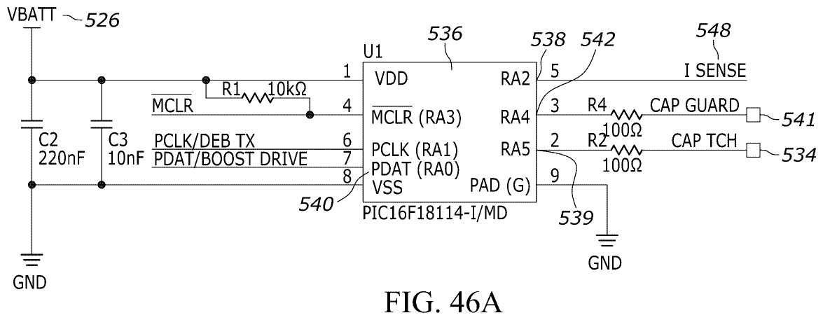

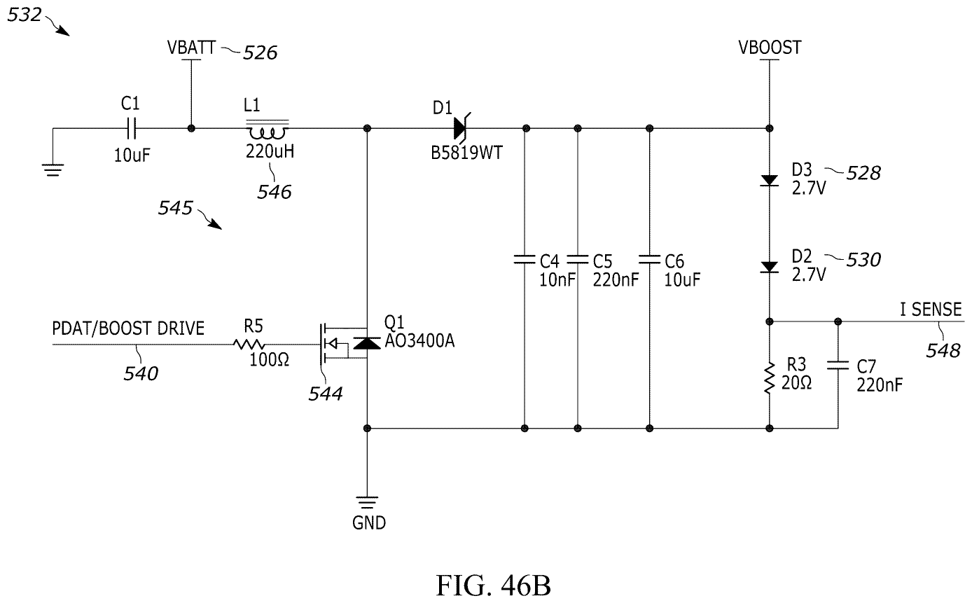

The contact lens case 500 includes a button 535 to receive input from the user. The button 535 may be on the base 508 of the case body 502. The button 535 may be between the two lens bays 510, 512. In one embodiment, the button 535 is a touch button, with the button 535 being a region of the case body 502 adjacent a sensor 534 (see FIG. 46) in the compartment 522 that detects when the user touches the button 535. The sensor 534 may be a touch sensor (e.g., a capacitive touch sensor, resistive touch sensor, or infrared touch sensor). The touch button 535 is formed without any openings or seams in the side of the case body 502, inhibiting water intrusion at the button 535. The contact lens case 500 includes multiple buttons to receive input from the user. In some forms, the sensor 534 provides a multi-touch function, where the user is able to provide input by swiping to turn the contact lens case 500 on or off.

In other embodiments, the button 535 may be a mechanical button, for example, a movable button the user may depress to provide input thereto. The case body 502 may include an opening at which the button 535 is positioned for engagement by a user. The contact lens case 500 may include an elastomeric overlay (e.g., a rubber or silicone overlay) over the button 535, enabling the user to press the button 535 while inhibiting fluid from entering the compartment 522.

The circuit board 524 (see FIG. 44) includes two lights 528, 530 (e.g., LEDs). The lights 528, 530 are each supported beneath a corresponding lens bay 510, 512 to illuminate the lens bays 510, 512 when turned on. The lights 528, 530 permit a user to take out or put in their contacts in a dark environment without having to turn on the lights in the room, a flashlight, etc. When the lights 528, 530 of the contact lens case 500 are turned on, the lights enable the user to locate the contact lens case 500, remove and/or secure the caps 504, 506, withdraw contact lenses from or insert contact lenses into the lens bays 510, 512, and view the amount of contact solution in an otherwise dark or dimly lit environment. The lights 528, 530 also enable a user to confirm their contact lenses are in the lens bays 510, 512, for example, upon taking out their contact lenses. The lights 528, 530 may have a soft color that minimizes the effect the lights 528, 530 have on the user's circadian rhythm. As one example, the lights 528, 530 may emit a light of a color known to not disrupt the body's production of melatonin, such as a red color. The lights also assist the user in installing their contacts in their eyes by illuminating a mirror.

In one embodiment, the caps 504, 506 may be different colors (e.g., a different color plastic) to indicate to the user which lens bay 510, 512 contains their right eye contact lens and which lens bay 510, 512 includes their left eye contact lens. Where the caps 504, 506 are translucent, upon turning the lights 528, 530 on, the caps 504, 506 illuminate in their respective colors, making identification of the respective lens bays 510, 512 apparent. This is particularly advantageous when a user is putting in their contact lenses and may not be able to read annotations on the caps 504, 506, especially in low light conditions.

In some embodiments, the contact lens case 500 (e.g., the case body 502 and/or caps 504, 506) is provided in a variety of different colors (e.g., different color plastic for the case body 502 and/or the caps 504, 506) to distinguish contact lens cases 500 from one another. For example, in a household where multiple individuals wear contact lenses, each individual may have a uniquely colored contact lens case 500 to aid in identifying their contact lens case 500 from the others. Additionally or alternatively, the contact lens case 500 may be provided with lights 528, 530 of a variety of different colors to distinguish different contact lens cases 500 from each other when the lights 528, 530 are turned on. In some forms, the lights 528, 530 are multi-color LEDs, with the color of the lights 528, 530 being selectable by the user by providing input to the contact lens case 500 via the button 535 or a wirelessly (e.g., Bluetooth) connected mobile phone application.

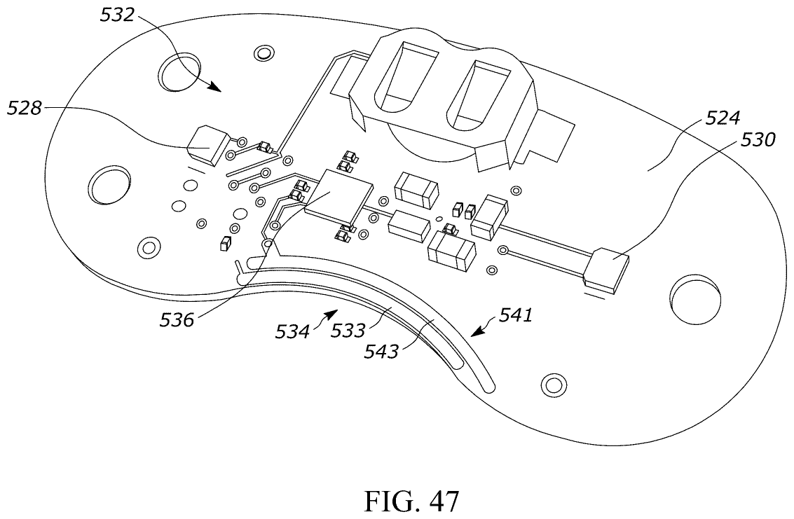

With respect to FIGS. 46A-46B, schematic diagrams of a lighting circuit 532 of the contact lens case 500 on the circuit board 524 are shown. The lighting circuit 532 includes the lights 528, 530, the sensor 534, and a controller 536. The battery 526 provides electrical power to the controller 536 and the lights 528, 530. The sensor 534 is configured to detect input from the user, e.g., to turn on the lights 528, 530. Where the sensor 534 is a touch sensor, the sensor 534 may be positioned in the compartment 522 of the case body 502 adjacent a portion of the case body 502 forming the button 535 to sense when a user is touching the case body 502 at the button 535. For example, the user may tap the button 535 and the sensor 534 may detect the input from the user. Regarding FIG. 47, in the embodiment shown, the sensor 534 includes a conductive trace 533 (e.g., copper) of the circuit board 524 adjacent the button 535. The controller 536 outputs an electrical pulse signal via an input/output pin 539 to the conductive trace 533 of the sensor 534 to generate a magnetic field at the button 535. In between each electric pulse, the controller 536 measures the voltage of the conductive trace 533 of the sensor 534 via the input/output pin 539 to detect a disruption of the magnetic field generated by the conductive trace 533, for example, by a user's finger being brought in proximity to the button 535.

In some embodiments, the lighting circuit 532 includes a sensor guard 541 to block stray electric and/or magnetic fields adjacent the sensor 534, to improve the accuracy of the controller 536 in detecting the user's finger at the button 535 and reduce false positives (e.g., due to other objects in the vicinity). The sensor guard 541 may include one or more conductive traces 543 (e.g., copper) of the circuit board 524 positioned inward of the conductive trace 533 of the sensor 534, for example, on the top and bottom sides of the circuit board 524. The controller 536 outputs an electric pulse signal via an input/output pin 542 to the conductive traces 543 of the sensor guard 541 to generate an electric field inward of and/or above and/or below the conductive trace 533 of the sensor 534 to shield the sensor 534, blocking stray electric fields inward of the sensor 534 and/or above or below the contact case 500 from interfering with the sensor 534. In other words, the sensor guard 541 aids to ensure that the sensor 534 detects disruptions in the electric field caused by objects outward of the sensor 534 (e.g., the user's finger), rather than from the inside of the case 500 or above or below the case 500. For example, liquid such as water from a sink or contact solution may be present on the contact lens case 500 or the countertop where a user takes out or puts in their contact lenses, which can disrupt the electric field at the sensor 534. The sensor guard 541 minimizes the impact of such liquid in affecting the electric field of the sensor 534, improving the accuracy of the sensor 534 in detecting actual button presses of the user at the button 535.

In other embodiments, the sensor 534 additionally or alternatively includes an inertial measurement unit (e.g., accelerometer and/or gyroscope) to detect motion of the contact lens case 500, for example, a specific motion pattern (e.g., shaking, a gesture, etc.).

The controller 536 may include a processor and memory. For example, the controller 536 includes an integrated circuit (e.g., an application-specific integrated circuit) to provide functionality to the contact lens case 500. The controller 536 detects input at the button 535, for example, via the sensor 534. For example, the controller 536 may receive a signal from the sensor 534 and detect when the user is touching the button 535 and providing input to the contact lens case 500. The controller 536 may cause the lights 528, 530 to turn on upon detecting user input at the button 535. In some embodiments, the controller 536 may require the user to hold the button 535 for a period of time (e.g., one second) to cause the lights to turn on. In some forms, the user may tap the button 535 a number of times or hold the button 535 for different lengths of time to provide different types of input to the contact lens case 500. For example, the user may tap the button 535 a certain number of times (e.g., three times) to cause the contact lens case 500 to flash or strobe the lights 528, 530. As another example, the user may hold the input region at the button 535 for a period of time (e.g., ten seconds) to enter a mode where the user is able to change the color of the lights 528, 530, e.g., by subsequently tapping the button 535 to cause the light color to change.

Regarding FIG. 46A, the controller 536 includes an input 539 to receive a signal from the sensor 534. The controller 536 may process the signal from the sensor 534 to detect input from the user (e.g., to turn the lights 528, 530 on). The controller 536 may determine the input command provided by the user, for example, based on the length of time the button 535 was engaged, the number of times the button 535 was engaged, etc. The controller 536 includes an output 540 to send a signal to cause the lights 528, 530 to turn on. The controller 536 may send the signal to cause the lights 528, 530 to turn on in response to detecting input from the user via the button 535.

Regarding FIG. 46B, another portion of the lighting circuit 532 is shown. As shown, the battery 526 provides electrical power to illuminate the lights 528, 530. The lighting circuit 532 includes a boost circuit 545 to control the flow of electrical power to the lights 528, 530. The boost circuit 545 includes a switching component 544 (e.g., a MOSFET) and an inductor 546. The switching component 544 receives the output signal from the output 540 of the controller 536. The controller 536 may pulse the output signal of the output 540 provided to the switching component 144 to control the state of the lights 528, 530 (e.g., whether they are in an on state or an off state). The controller 536 may adjust the duty cycle of the pulse signal output from the output 540 to control the brightness of the lights 528, 530. The higher the duty cycle of the output signal (e.g., the greater the pulse width), the brighter the lights 528, 530 and vice versa due to the amount of energy stored in the inductor 546 during the pulse. The controller 536 includes a current sensing input 548 to sense the amount of electrical current flowing through the lights 528, 530, which corresponds to the brightness of the light, providing feedback to the controller 536 and enabling the controller 536 to adjust the brightness of the lights to the desired brightness. The user may provide input to the contact lens case 500 (e.g., via the button 535, smartphone application) to set a brightness of the lights 528, 530.

The controller 536 may include a timer that tracks how long the user has used the contact lens case 500. The controller 536 may indicate to the user when they should replace their contact lenses and/or the contact lens case 500 based on the timer. The controller 536 may detect that the user has begun using the contact case and start the timer. The contact lens case 500 has an internal clock that the controller 536 uses to track time. The controller 536 may detect that the user has begun using the contact case when the user activates the contact lens case 500, for example, when the user first holds the button 535 for a period of time (e.g., three seconds) to activate the contact lens case 500 or to turn the lights 528, 530 on. The controller 536 may also detect that the user has begun using the contact case when the user removes a battery safety tab provided when packaged or when the user input is provided after a long period of inactivity (e.g., after the product has been in storage).

The controller 536 may indicate to the user when the timer expires, for example, by changing the color of the lights 528, 530 (e.g., from white to red), by flashing the lights, etc. The timer may be set to expire after 90 days, 60 days, 45 days, 30 days, 14 days, 7 days or less. The length of the time may correspond to the frequency at which the user is to replace their contact lenses. The user may provide input to the contact lens case 500 to reset the timer, for example, upon discarding their old contact lenses and using new contact lenses. For example, the user may provide input via the button 535 (e.g., press and hold for three seconds) or the contact lens case 500 may include a separate button 537 on top of the case body 502 the user may press to reset the timer. In some embodiments, the contact lens cases 500 are preprogrammed with specific timers, for example, such that a user purchases a contact lens case 500 with a timer that corresponds to their contact lens replacement prescription. In some embodiments, the contact lens case 500 permits the user to adjust the length of the timer, for example, by providing input via the button 535. The contact lens case 500 itself may be due for replacement after a period of time (e.g., 90 days) to comply with recommended hygiene guidelines. The contact lens case 500 may not permit the timer to be reset after expiration of the contact lens case replacement period. The controller 536 may control the lights 528, 530 in a different way (e.g., color, flashing pattern, color and flashing pattern, or a disappearing or color-changing ring of light) to indicate when the contact lenses need to be replaced and when the contact lens case 500 itself needs to be replaced. The lights 528, 530 thus make the user aware during every lens handling that the contact lenses and/or contact lens case 500 need to be replaced and when, making the user more cognizant of replacement intervals. Additionally or alternatively, the contact lens case 500 includes a speaker, buzzer, or vibrator to make a noise or vibrate to indicate to the user when to replace their contact lenses and/or the contact lens case.

The contact lens case 500 includes multiple lighting modes. Each lighting mode may be selected by pressing the button 535 in a pattern corresponding to the mode, such as a certain number of times. For example, the contact lens case 500 may include a contacts mode, a night light mode, a fade mode, and/or a fun mode. Each mode may be selected by tapping the button 535 one, two, three, or four times. In the contacts mode, the controller 536 causes the lights 528, 530 to turn on with a constant brightness to enable the user to take out or put in their contact lenses. The lights 528, 530 may automatically turn off after a predetermined length of time (e.g., two minutes). In the night light mode, the controller 536 causes the lights 528, 530 to turn on dimly to provide light for the user, for example, as they get ready for bed and navigate in a dark environment (e.g., with the house lights off). The lights 528, 530 may automatically turn off after a predetermined length of time (e.g., two minutes). In the fade mode, the controller 536 turns the lights 528, 530 on and dims the lights and/or softens the color over a period of time (e.g., five minutes). For example, the user may set the contact lens case 500 on their nightstand in the fade mode, with the light gradually dimming and/or softening (e.g., similar to the changing light at sunset) to aid the user in falling asleep. In the fun mode, the controller 536 may turn the lights 528, 530 on in different colors, cycle the lights through a sequence of colors, and/or turn the lights 528, 530 on in a flashing pattern. The fun mode may help make children excited to use their contact lens case 500, aiding to establish good habits by motivating children to take out their contact lenses each night.

The controller 536 of the lighting circuit 532 may monitor the voltage of the battery 526. The controller 536 may detect when the charge of the battery 526 is low. The controller 536 may output an alert (e.g., flashing of the lights 528, 530, changing the light color) that the battery 526 is low. The alert may notify the user that the battery 526 is about to die and to replace the contact lens case 500, replace the battery 526, or charge the battery 526.

The lighting circuit 532 may include other electrical circuit components such as capacitors, resistors, inductors, diodes, etc. to regulate the current, stabilize the voltage, and filter out noise and to create a reliable and efficient circuit. As examples, the lighting circuit 532 may include the following electrical components as noted on the schematic.

| Description | Quantity | Manufacturer | Part Number |
|---|---|---|---|
| BATTERY LITHIUM 3 V COIN | 1 | PKCELL | CR1225 |
| 12.5 MM | | | |
| CAP CER 10UF 25 V X7R 1206 | 2 | Samsung Electro- | CL31B106KAHNFNE |
| | | Mechanics | |
| CAP CER 0.22UF 16 V X7R | 3 | Samsung Electro- | CL05B224KO5NNNC |
| 0402 | | Mechanics | |
| CAP CER 10000PF 50 V X7R | 2 | Samsung Electro- | CL05B103KB5NNNC |
| 0402 | | Mechanics | |
| DIODE SCHOTTKY 40 V | 1 | Shenzhen | B5819WT |
| 350MA SOD523 | | Slkormicro | |
| | | Semicon Co., Ltd. | |
| LED LUXEON WHT 4000K | 2 | Lumileds | L128-4070SA35A00E1 |
| 2835 | | | |
| BATTERY RETAINER COIN | 1 | Keystone | 3000 |
| 12 MM SMD | | Electronics | |
| FIXED IND 220UH 80MA 5.4 | 1 | Taiyo Yuden | LB3218T221K |
| OHM SMD | | | |
| MOSFET N-CH 30 V 5.7 A | 1 | Alpha & Omega | AO3400A |
| SOT23-3L | | Semiconductor | |
| | | Inc. | |
| RES SMD 10K OHM 1% | 1 | Vishay Dale | CRCW040210KOFKEDC |
| 1/16W 0402 | | | |
| RES SMD 100 OHM 1% 1/16W | 3 | Vishay Dale | CRCW0402100RFKED |
| 0402 | | | |
| RES SMD 20 OHM 1% 1/16W | 1 | Vishay Dale | CRCW040220ROFKED |
| 0402 | | | |
| IC MCU 8 BIT 7 KB FLASH | 1 | Microchip | PIC16F18114T-I/MD |
| 8VDFN | | Technology | |

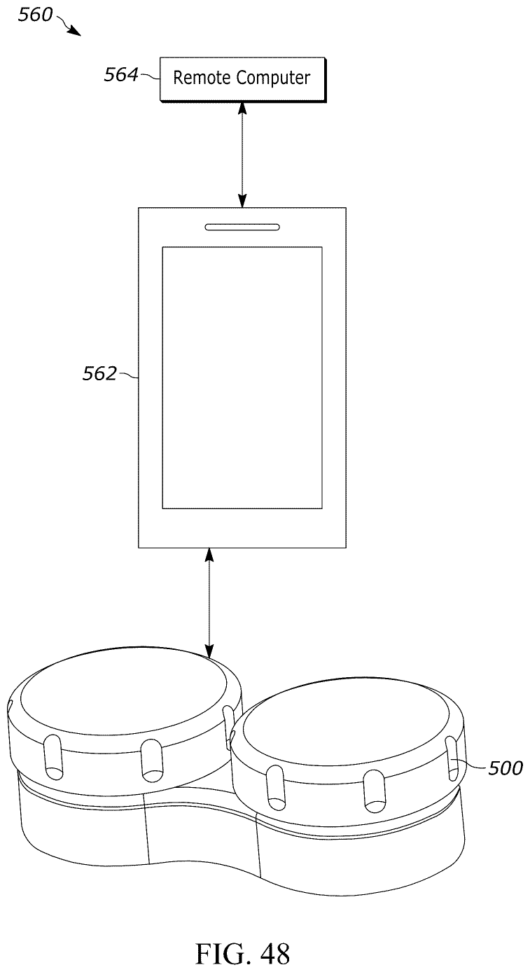

With reference also to FIG. 48, in some embodiments, the contact lens case 500 is part of a contact lens system 560. The contact lens system 560 includes the contact lens case 500 and one or more remote devices such as a user device 562 (e.g., smartphone, tablet, etc.) and/or a server computer 564. In such embodiments, the contact lens case 500 includes communication circuitry 566 (see FIG. 44) for communicating with the remote devices. The communication circuitry 566 may include a wireless transmitter and/or receiver. The controller 536 may use the communication circuitry 566 to communicate via Wi-Fi, Bluetooth, and/or other indirect and/or direct wireless communication protocols. The contact lens case 500 may be associated with a computer application, such as a smartphone application. The user may use the smartphone application on their user device 562 to wirelessly connect to the contact lens case 500 via the communication circuitry 566. The contact lens case 500 may communicate data to the user device 562 for display to the user via the smartphone application, for example, contact usage data such as how many days before their contact lenses need to be replaced, contact lens case data such as the remaining battery life of the contact lens case 500, etc.

The contact lens system 560 may be used to aid the user in complying with the recommended guidelines for wearing and caring for contact lenses to prevent eye infections and other complications. In some embodiments, the contact lens case 500 includes sensors to detect when the caps 504, 506 are attached or removed from the case body 502, which may indicate whether the user currently has their contact lenses in or out. The contact lens case 500 may communicate the times when the caps 504, 506 are attached and removed to the user device 562. Additionally or alternatively, the contact lens case 500 may track times when the user turns on the lights 528, 530 or detect motion of the contact lens case 500 (e.g., with an IMU) to track when the user is likely taking out or putting in their contact lenses. The contact lens system 560 may thus track contact lens wear time and usage patterns. The user device 562 may provide a report to the user via the smartphone application, prompting the user to comply with contact lens usage guidelines, for example, to take out their contact lenses each night. In some embodiments, the smartphone application detects when the user has attached a charging cable to their user device (which may correlate to when the user is going to bed) and prompts the user to remove their contact lenses, e.g., via a notification. In some embodiments, the smartphone application outputs a notification to the user each night at a set time (e.g., a time the user indicates or the contact lens system 560 learns when they typically get ready for bed) to remind the user to take out their contact lenses.

In some embodiments, the smartphone application monitors the user's compliance and provides the user with a compliance score or streak (e.g., number of days in a row the user had taken out their contacts) to motivate the user to comply with contact lens usage guidelines. The contact lens system 560 may detect when the user takes out their contact lens (e.g., sensing when the closure caps are removed and attached, lights turned on/off, motion) or may receive input from a user via the application confirming they removed their contact lenses.

In some embodiments, the smartphone application includes an option the user may select to reorder contact lenses and/or contact lens cases 500. The smartphone application may permit the user to opt in to a subscription plan where new contact lenses and/or contact lens cases 500 are automatically shipped to the user to ensure the user has new contact lenses and/or a new contact lens case 500 when due for replacement. The smartphone application may receive contact usage data from the contact lens case 500 as discussed above (e.g., when the user began using a pair of contact lenses, or started using the contact lens case) and determine when to reorder contact lenses and/or a new contact lens case upon determining the contact lenses and/or contact lens case 500 needs to be replaced based on recommended compliance guidelines. The smartphone application may permit the user to indicate how many pairs of contact lenses a user has (e.g., in a package of contact lenses) and may track how many the user has left each time the contact lenses are being replaced to enable reordering when the user runs low. Upon determining that the user is running low on contact lenses and/or contact lens cases 500, the smartphone application may prompt the user to reorder new contact lenses and/or contact lens cases 500 (e.g., by outputting a notification to the user) or may automatically reorder the contact lens cases 500.

In some embodiments, the contact lens case 500 provides an option to the user enabling the user to reorder contact lenses and/or contact lens cases 500 from the contact lens case 500. For example, the contact lens case 500 may cause the lights 528, 530 to change color or to flash according to a pattern that indicates the user should reorder contact lenses and/or a new contact lens case 500 soon. The user may tap and/or hold the button 535 to opt to reorder more contact lenses and/or a contact lens case 500. The contact lens case 500 may communicate the user's input to reorder to the smartphone application, which facilitates reordering and payment.

The user may also use the smartphone application to control the contact lens case 500. For example, the smartphone application may permit the user to select a color for each light 528, 530, to reset the contact lens replacement timer, to change a length of the contact lens replacement timer, to program customer modes (e.g., light colors, sequences), to remotely cause the lights 528, 530 to turn on or make a sound (e.g., to help locate the contact lens case 500 in a travel bag or other location), to set a time for the lights 528, 530 to remain on before automatically turning off, etc. The contact lens case 500 and/or the associated smartphone application may store data regarding when the user has reset the timer which indicates the user has replaced their contact lenses. The contact lens case 500 and/or smartphone application may periodically communicate this lens replacement data to a remote server, for example, to enable tracking of compliance with replacement prescriptions.

In another embodiment, the lens bays 510, 512 are separable from the base 508. The lens bays 510, 512 may be detached from the base 508, for example, for cleaning and/or replacement (e.g., with new lens bays). As another example, the lens bays 510, 512 are detached from the base 508 and secured to a new base 508, e.g., when the battery 526 of the old base 508 dies. The lens bays 510, 512 may be threaded to the base 508. For example, the lower portion of the lens bays 510, 512 may include threading that cooperates with threading in corresponding a recess or opening of the base 508. Contact lens case 500 may include a seal such as a O-ring to seal the interface between the lens bays 510, 512 and the base 508 to inhibit liquid (e.g., contact solution) from entering the base 508.

In some embodiments, the smartphone application may include an option for the user to grant their Eye Care Provider (ECP) access to their contact lens and/or contact lens case usage data. By enabling this feature, the ECP is able to review the user's contact lens wear patterns, replacement history, compliance scores, and other data collected by the smartphone application. The ECP is thus able provide personalized suggestions or reminders to help users improve compliance with replacement schedules and improve eye health. Additionally, the ECP could initiate re-ordering prompts to be presented to the user for new contact lenses or cases when needed, supporting the user in maintaining healthy habits. This connectivity offers eye doctors greater accountability and oversight of their patients.

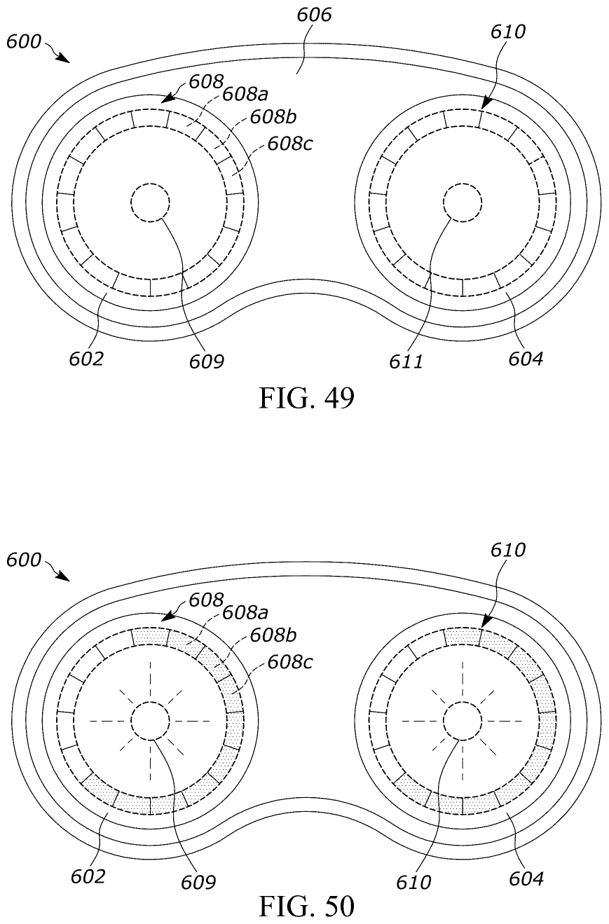

Regarding FIGS. 49 and 50, a contact lens case 600 is provided that is similar to the embodiments discussed above such that the differences are primarily highlighted. The contact lens case 600 is shown with the closure caps removed from the lens bays 602, 604 of the case body 606. The contact lens case 600 includes light arrays 608, 610 each positioned below the lens bays 602, 604 and in the compartment of the case body 606. The light arrays 608, 610 may be in addition to lights 609, 611 that illuminate the lens bays 602, 604 like the previous embodiments. The light arrays 608, 610 may be used to provide a visual indication to the user of the timer, for example, the time remaining until the contact lenses are to be replaced. In the embodiment shown, the light array 608 of the lens bay 602 includes a plurality of individually controlled lights 608a, 608b, 608c, etc. (e.g., LEDs) arranged in a circle. The light array 610 may have a similar arrangement. Each light 608a, 608b, 608c, etc. of the light array 608 illuminates a segment of the circle. As time passes, the individual lights 608a, 608b, 608c of the light array 608 are sequentially turned off to progressively darken segments of the circle. For example, the lights 608a, 608b, 608c are sequentially turned off as time passes to decrease the length of the lit portion of the circle until the timer expires, at which point the entire circle of lights 608a, 608b, 608c is no longer illuminated or the entire circle blinks red in color. The time for the lights 608a, 608b, 608c, etc. to be turned off all the way around the circle corresponds to the user's replacement prescription. For example, the controller of the contact lens case 600 may use the light array 608 to indicate the percentage of the 60 day, 30 day, 14 day, 7 day or less replacement cycle that has elapsed. The progression of the darkening around the circular light array 608 indicates to the user how much time remains before the timer expires and their contact lenses are to be replaced. The user may view the progression of the lighting of the lights 608a, 608b, 608c around the circle to quickly ascertain how soon their contact lenses are to be replaced. In other embodiments, the individual lights 608a, 608b, 608c of the light array 608 are sequentially illuminated as time passes to progressively illuminate segments of the circle when the contact case is in use.

The light arrays 608, 610 of each lens bay 602, 604 may be capable of changing colors or may include two sets of different color lights. The controller may sequentially change a lighting characteristic (e.g., a color or brightness) of the lights 608a, 608b, 608c, etc. to indicate the time remaining on the timer. For example, when the timer begins, all of the lights 608a, 608b, 608c, etc. are the illuminated the same color (e.g., white), and with the passing of time (e.g., each day) the lights 608a, 608b, 608c are progressively changed to illuminate in a different color (e.g., red). In other words, the length of the red portion of the circle may grow over time and, when the timer has elapsed, the entire circle is red which indicates the contact lenses are to be replaced.

In some embodiments, the light arrays 608, 610 each display a number that indicates the number of days remaining on the timer. For example, the left lens bay 602 displays the tens digit of the timer and the right lens bay 604 displays the ones digit. As one example, where the timer has 14 days remaining, the left lens bay 602 displays a “1” and the right lens bay 604 displays a “4.” The light arrays 608, 610 may, for example, include a seven segment light display or an LED matrix to present numbers to the user.

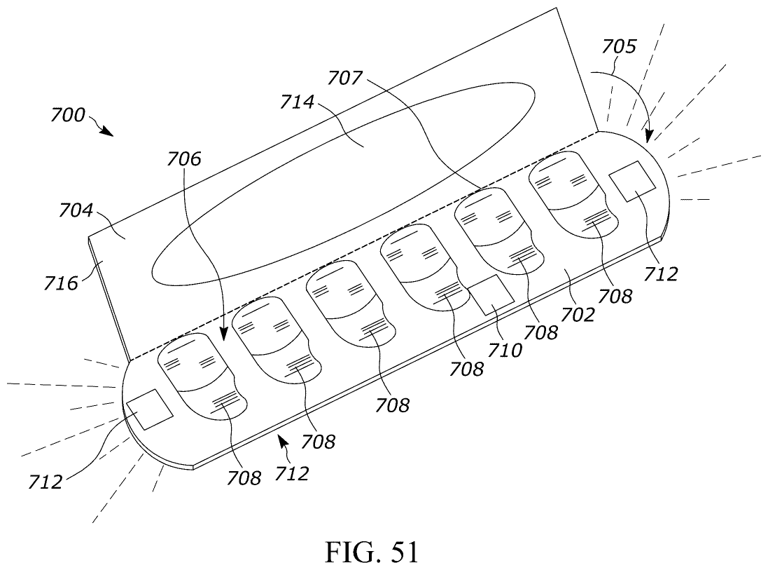

Regarding FIG. 51, a contact lens case 700 is provided according to another embodiment. The contact lens case 700 may be a storage or a travel case that may be used to store new contact lenses, for example, contact lenses in the packaging from the manufacturer. The contact lens case 700 may be an aftermarket case for daily disposable contact lenses. The contact lens case 700 includes a case body 702 and a lid 704 hingedly connected to the case body 702. The lid 704 is movable between an open position (as shown) and a closed position where the lid is moved in direction 705 to close the case body 702. In some forms, the contact lens case 700 includes a hinge 707 connecting the case body 702 and the lid 704. In other forms, the case body 702 and/or the lid 704 are formed of a flexible material that provides a living hinge that permits the lid 704 to be moved between the open and closed positions.

The case body 702 includes a storage compartment 706. The storage compartment 706 may be used to store new contact lens packages 708, commonly known as “blister packs.” The contact lens case 700 may serve as a travel case for those who replace their contact lenses daily, storing one or more sets of contact lenses for the user. The case body 702 may include a lighting circuit 710 similar to those discussed in the embodiments above. The lighting circuit 710 may be in the case body 702, for example, disposed in an electronics compartment of the case body 702. The lighting circuit 710 includes one or more lights 712 that may be illuminated to provide light for a user taking out or putting in their contacts, for example, in a dark environment as discussed above. The lighting circuit 710 may emit light across the bottom of the storage compartment 706 and up through all the new contact lens packages 708 (e.g., blister packs) to provide a user with light as they open a contact lens package 708 and handle a contact lens removed therefrom, e.g., in a dark environment. In one embodiment, the lights 712 may be illuminated when the lid 704 is moved to the open position. The lighting circuit 710 may include a sensor to detect whether the lid 704 is in the open or closed position. In one embodiment, the case body 702 includes an input (e.g., a button or switch) like the embodiment above that is used to control the state of the lights 712. The lid 704 may include a mirror 714 on an inner surface 716 of the lid 704. The user may use the mirror 714 of the lid 704 to aid in taking out or putting in their contacts, or for otherwise getting ready (e.g., combing hair, applying makeup, etc.) in a dark environment.

In some embodiments, the contact lens case 700 may store a contact lens case (e.g., a conventional contact lens case). The contact lens case 700 may be sized to store the contact lens case and/or one or more new contact lens packages 708. The contact lens case 700 may include a lighting circuit as discussed above to provide lighting to a user when taking out or putting in their contact lenses. The lighting circuit may also be illuminated to indicate to the user when to replace their contact lenses and/or their contact lens case.

The following describes additional aspects related to illuminating a contact lens case.

A contact lens case may be illuminated by a light pad. More specifically, the light pad may be planar so that the case can be placed on the pad and light emitted from the pad illuminates the case from below. The lighted surface of the pad may include a layer that causes the light to diffuse evenly through the surface. The pad may be electrically powered through a wired connection to an electric power source or through one or more batteries carried by the pad. The one or more batteries may be rechargeable and/or replaceable. The light source may be one or more LED lights. The light pad may include a circuit and a circuit board like the ones described herein.

Another device may be a light diffuser pad that removably attaches to a light source. For instance, the light source may be a flashlight or a smartphone with a flashlight feature. The pad may be attached over the light source and any lens case may be laid on the pad. For example, the diffuser pad may be removably snapped onto a smartphone over the light source so that it diffuses and softens light in the room but provides enough light to insert or remove contact lenses when the case is placed flat upon the diffuser pad. The diffuser pad may have a lip on its entire edge so that any spills might be contained, and to hold any lens case in place. The lens case may be one of the ones described herein without the circuit board so as not to block the light.

The lens case may include glow in the dark technology. This may provide the necessary illumination without the need for a powered lighting source. It also may be used in conjunction with a powered light source, such as those described herein. The glow in dark feature enables one to easily locate a contact lens case in the dark or in a carrying bag, such as a purse, briefcase, backpack, etc. The technology may be phosphors mixed into the material used to make the case. These phosphors provide light though the phosphorescence process. Instead of or in addition to, the contact lens case may be used with an external glow in the dark enhanced accessory such as a pad featuring glow in the dark technology. The case would be placed in the pad.

In one embodiment, the contact lens case indicates an indicator that undergoes a visual chemical change (e.g., change in color, fading color) over a predetermined period—such as 7, 14, 30, or 90 days—to provide a passive, visual cue for contact lens or contact lens case replacement. In some forms, the case body and/or caps are formed of a material that undergoes the visual chemical change over the predetermined period. In some forms, an ink, label, or indicator strip is printed or adhered to the case body and/or cap that undergoes the visual chemical change over the predetermined period. For example, the indicator may be green upon removal from a package or when a cover is removed from covering the indicator and the green color fades to white over the predetermined period. Such an indicator provides a non-electronic solution for tracking lens or case replacement schedules, offering users a reliable way to monitor usage without relying on powered circuits or lighting elements.

As mentioned above, the contact lens case may be enhanced with multiple color lighting options. The colors may be selected by using a switch (such as the on/off button) to set different colors, sequences of colors, or modes of color arrays and/or sequences. The colors may be selected based on personal preferences or may be selected for therapy reasons, such as a red-light mode for red light therapy.

The contact lens case may include the ability to set the amount of light emitted to a user preference. For example, the on/off could be cycled through a few different ON positions to set the amount of lighting. For instance, there could be three light settings and one OFF setting, for a total of four settings. So, you would press the button four times to cycle through these options. Each light setting would emit a different amount of light, with one being the highest amount, one being the lowest amount, and the third being an intermediate amount. While this illustrates four settings, it could be any number of settings. In addition to, or alternatively, a variable switch may be provided to select from an infinite number of light illumination amounts.

The contact lens case may include a timer that turns the lighting circuit OFF after a predetermined amount of time. This would preserve the battery in the event the user inadvertently fails to turn the light off. The circuit might include a processor with a clock to manage the auto-off feature. The case may be programmable to set the amount of time for illumination before being automatically turned off. The case could be provided with a default or factory set time amount, such as some setting at or between 30 seconds and five minutes. The case may also come with a battery activation slip between the battery, not activating until the customer pulls the slip, automatically starting its pre-programmed 90-day life as prescribed by doctors, in which the battery automatically disconnects upon the 91^{st} day. Other life cycles may be used as well, such as 60, 30, 14, or 7 days, or less.

The contact lens case also may include solar charging for its power source. The case might include a solar panel mounted to its exterior and connected to the lighting circuit using the appropriate electrical components to convert the solar power to charging power for the onboard power storage device, such as a battery or capacitor.

The contact lens case may also include a manual activated generator. For instance, it may have a small handle or dial that is turned to cause a magnet to move in a coil to generate electrical energy. The electrical energy may be used immediately and/or stored in a battery or capacitor. The generator may be electrically connected to the electrical circuit.

Another case may be provided that could be sized to house a contact lens case. The case may include an illumination circuit that turns on when the lid hinges open. The inside of the lid may include a mirror. The lights may be in or at the bottom of the case. A contact lens case may be inserted in the case to be illuminated, and the illumination and the mirror may be used to apply one's contacts or to remove one's contacts. The light source could be any one of the foregoing lighting circuits fitted into or at the bottom or sides of the case. The bottom of the case may be designed to diffuse the light across the bottom of the case.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution.

What is claimed is:

1. A contact lens case comprising:
a main body defining at least two lens bays on one side of the main body and a compartment on an opposite side of the main body;
at least two caps, one removably attached to one of the at least two lens bays and another removably attached to another of the at least two lens bays; and
a lighting circuit housed in the compartment, the lighting circuit including a power source, at least one light source, and a control input to change an illumination state of the at least one light source.

2. The contact lens case of claim 1 wherein the at least one light source includes at least one light emitting diode.

3. The contact lens case of claim 1 wherein the main body is translucent.

4. The contact lens case of claim 2 wherein the at least two caps are translucent.

5. The contact lens case of claim 1 further comprising a bottom attached to the main body and forming a watertight seal therebetween to close the compartment.

6. The contact lens case of claim 1 wherein the control input enables changing a brightness level of the at least one light source.

7. The contact lens case of claim 1 wherein the at least one light source is configured to emit light in a plurality of different colors.

8. The contact lens case of claim 1 wherein the lighting circuit includes a timer that causes the at least one light source to be changed to an off state after a predetermined amount of time in an on state.

9. The contact lens case of claim 1 further comprising a solar panel that provides energy for powering the lighting circuit and/or charging the power source.

10. The contact lens case of claim 1 further comprising a generator electrically connected to the lighting circuit to provide energy for the lighting circuit and/or the power source.

11. The contact lens case of claim 1 wherein at least one of the main body and one of the at least two caps includes material that glows naturally.

12. The contact lens case of claim 1 wherein the at least two lens bays include a first lens bay and a second lens bay,
wherein the at least one light source includes a first light source and a second light source, the first light source being beneath the first lens bay and the second light source being beneath the second lens bay.

13. The contact lens case of claim 1 wherein the lighting circuit includes a timer and a controller, the controller configured to control the at least one light source based on the timer to indicate to a user when to replace contact lenses.

14. The contact lens case of claim 1 wherein the at least one light source includes a light array,
wherein the lighting circuit includes a controller configured to:
track when contact lenses are due for replacement; and
upon receiving input to turn the at least on light source on, control the light array to provide a visual indication with the light array of a time remaining on the timer.

15. The contact lens case of claim 14 wherein the light array includes a plurality of light sources arranged in a circle,
wherein to control the light array to provide the visual indication includes progressively changing a lighting characteristic of each light source of the plurality of light sources over time.

16. The contact lens case of claim 1 wherein the control input includes a touch sensor to detect user engagement with an input portion of the main body.

17. The contact lens case of claim 16 wherein the touch sensor includes a sensing conductor at the input portion of the main body and one or more blocking conductors adjacent the sensing conductor, the blocking conductors shielding the sensing conductor from electrical and/or magnetic interference.

18. The contact lens case of claim 1 wherein the lighting circuit includes communication circuitry operable to communicate with a remote computing device, the lighting circuit using the communication circuitry to at least one of:
send data to the remote computing device; or
receive input from the remote computing device.

19. The contact lens case of claim 18 in combination with the remote computing device, the remote computing device configured to run an application associated with the contact lens case, the application configured to prompt the user to take out or discard their contact lenses.

20. A lighting device for a contact lens case comprising:
a body sized and shaped to attach to a contact lens case;
a lighting circuit attached to the body, the lighting circuit including:
at least one light source to illuminate the contact lens case;
a battery disposed in a sealed compartment of the body to power the at least one light source; and
a user input to change an illumination state of the at least one light source.

21. An illumination container for a contact lenses comprising:
a main body defining a compartment sized to receive a contact lens case and/or one or more packaged contact lenses, the main body have a bottom surface at the compartment;
a cover movable relative to the main body between an open position to provide access to the compartment and a closed position to close off access to the compartment; and
a lighting circuit at the main body, the lighting circuit including a power source and at least one light source operable to emit light from the main body.

22. The illumination container of claim 21 wherein the cover is removed from the body in the open position, and wherein the at least one light source is turned ON when the cover is removed from the main body.

23. The illumination container of claim 21 wherein the cover is attached to the main body with a hinge and pivotable about the hinge between the open position and closed position, wherein and the light source is turned on when the cover is pivoted to the open position.

24. A computing device for contact lens management, the computing device comprising:
memory storing an application for contact lens management;
communication circuitry operable to communicate with an electronic contact lens case for storing one or more contact lenses;
a processor operably coupled to the memory and the communication circuitry, the processor configured to run the application including to:
receive, via the communication circuitry, contact lens usage data pertaining to one or more contact lenses from the electronic contact lens case; and
based on the contact lens usage data, send a signal to the electronic contact lens case to cause the electronic contact lens case to notify the user to replace the one or more contact lenses.

25. The computing device of claim 24 further comprising a user interface operably coupled to the processor, wherein the processor is further configured to output a notification via the user interface reminding the user to take out the one or more contact lenses.

26. The computing device of claim 24 wherein the processor is further configured to detect when the computing device is connected to a power source, wherein the processor outputs the notification reminding the user to take out the one or more contact lenses is in response to detecting the user has connected the user device to a power source.

27. The computing device of claim 24 wherein the processor is further configured to send a signal to the electronic contact case to cause the electronic contact lens case to notify the user to replace the electronic contact case.

28. A contact lens case comprising:
a main body defining at least two lens bays on one side of the main body and a compartment on an opposite side of the main body;
at least two caps, one removably attached to one of the at least two lens bays and another removably attached to another of the at least two lens bays;
a lighting circuit housed in the compartment, the lighting circuit including a light array, a control input to change an illumination state of the light array, and a controller; and
the controller configured to:
track when contact lenses are due for replacement; and
upon receiving input to turn on the light array, control the light array to provide a visual indication with the light array of a time remaining on the timer.

29. A contact lens case comprising:
a main body defining at least two lens bays on one side of the main body and a compartment on an opposite side of the main body;
at least two caps, one removably attached to one of the at least two lens bays and another removably attached to another of the at least two lens bays;
communication circuitry disposed in the compartment and operably to communicate with a remote computing device; and
a controller disposed in the compartment and operably coupled to the communication circuitry, the controller configured to use the communication circuitry to at least one of:
send data of the contact lens case to the remote computing device; or
receive input from the remote computing device to change a setting of the contact lens case.
